(19) United States
(12) Patent Application Publication
(10) Pub. No.: US 2026/0022618 A1
(43) Pub. Date: Jan. 22, 2026

(54) APPARATUS AND METHODS FOR FORMING FORMATION-TO-FORMATION SEALS IN A WELLBORE

(71) Applicant: Robertson Intellectual Properties, LLC, Arlington, TX (US)

(72) Inventors: Michael C. Robertson, Arlington, TX (US); Douglas J. Streibich, Arlington, TX (US); Pouya Mahbod, Arlington, TX (US)

(73) Assignee: Robertson Intellectual Properties, LLC, Arlington, TX (US)

(21) Appl. No.: 19/275,566

(22) Filed: Jul. 21, 2025

Related U.S. Application Data
(60) Provisional application No. 63/673,593, filed on Jul. 19, 2024.

(51) Int. Cl. E21B 33/138; C09K 8/42; E21B 33/12; E21B 36/00

(52) U.S. Cl. CPC E21B 33/138; C09K 8/426; E21B 33/12; E21B 36/008

(57) ABSTRACT

An apparatus and methods for sealing a wellbore extending through a rock formation. An implementation of such apparatus comprises a delivery apparatus configured to be conveyed within the wellbore, wherein the delivery apparatus comprises a chamber therein, and a sealing material disposed within the chamber. The sealing material is configured to undergo an exothermic reaction when ignited. The exothermic reaction produces a molten bonding material. The delivery apparatus is configured to direct the molten bonding material into the wellbore such that the molten bonding material contacts the rock formation. The molten bonding material bonds with the rock formation when the molten bonding material solidifies thereby sealing the wellbore.

### CROSS REFERENCE TO RELATED APPLICATIONS

The present application claims priority to and the benefit of U.S. Provisional Patent Application No. 63/673,593, titled “APPARATUS AND METHODS FOR FORMING FORMATION-TO-FORMATION SEALS IN A WELLBORE,” filed Jul. 19, 2024, the entire disclosure of which is hereby incorporated herein by reference.

### BACKGROUND

Constructing a subterranean well for producing hydrocarbons and/or sequestering carbon dioxide (CO₂) requires a capital investment, with an expectation of a return on capital that is repaid over the life of the well, followed by a permanent abandonment of all or part of the well once storage or producing zones have reached the end of their economic life or the well's structural integrity has become an issue. For the hydrocarbon extraction industry, the producing life of a well is typically 5 to 20 years of production. For the underground CO₂ sequestering, the wells may be designed for a 50-year life span. However, over time, hydrocarbon extraction wells and storage wells may encounter integrity issues that require intervention, maintenance, or abandonment.

Well abandonment often includes inserting a plug within a wellbore to permanently seal the wellbore in a manner that prevents or inhibits leaking of downhole fluids (liquids and/or gases) in the uphole direction past the plug. However, prior art plugs and other methods for permanently sealing a wellbore have proved inadequate, and as such, the plugs and methods often fail, allowing downhole fluids to leak through or around the plug, in an uphole direction and to the wellsite surface from which the wellbore extends.

Furthermore, with growth in the requirement to sequester CO₂, the use of depleted oil and gas reservoirs for carbon storage is becoming increasingly common. However, a significant challenge arises when CO₂ reacts with water, forming carbonic acid (H₂CO₃), which can corrode the cement and casing of plugged and abandoned wells, potentially leading to the formation of leakage pathways back to the surface. Ensuring long-term integrity of seals within a wellbore is crucial for the success of carbon capture, utilization, and storage (CCUS) operations, where CO₂ capture is intended to be maintained for long periods of time (e.g., decades).

Currently, bismuth-style plugs are being considered as a solution to mitigate migration of fluids to the surface, past various plugs that are sealing a wellbore. However, while bismuth is known to resist CO₂, bismuth is untested with respect to long-term performance in CCUS environments, particularly under high-pressure and high-temperature conditions.

Also, CO₂ gas can leak from a CO₂ storage wells across the rock formation to adjacent abandoned oil and gas wells that are not involved in CO₂ sequestering operations. The CO₂ gas can then leak past any sealing plugs installed in adjacent oil and gas wells and escape to the surface. Therefore, permanently sealing adjacent oil and gas wells to inhibit CO₂ leaks is an important part of large field CO₂ capture operations.

Prior art failures in permanently sealing subterranean wells can be traced to the inability of existing technology to create a permanent seal against the rock formation through which wellbores extend, such as cap rock zones of the rock formation. Another source of failure in permanently sealing subterranean wells includes failing to generate a competent physical pressure barrier without the use of additional barrier material (typically cement) being placed above a problematic plug. Though traditionally required by regulatory authorities, placement of a secondary barrier has been used as “insurance” against a single failure potential. This secondary barrier requirement represents a significant cost to the user and has considerable limitations for long-term sequestration. Further, another source of failure in permanently sealing subterranean wells includes the limitations of primary cement and/or metal bonding to non-metal material (e.g., cement, geologic matrix, etc.), which allows formation of a contraction zone that generates a pathway (annulus) through a barrier zone, thereby allowing escape of reservoir fluids, including injected fluids and fluid by-products, to the surface and the eventual release to the atmosphere. The injected fluids tend to migrate to prior production zones of a well, allowing the fluids or their decomposition gases and/or byproducts to be released back to the surface due to poor, degraded, corroded, or inadequate sealing methodologies.

An example of prior art includes International Patent Application Publications Nos. WO2020/2166920A1 and WO2020/2166421A1, and Norwegian Patent Application Publication No. NO202007921A1, all filed by applicant Interwell P&A AS. The publications disclose methods of performing permanent plugging and abandonment operations of wells and permanent plugging and abandonment barriers formed by the methods. Specifically, the publications disclose technology called RockSolid, which is a thermite-based plug for fusing a wellbore and its components, such as casing and cement together. However, the Interwell technology does not address several important needs, including the need for long-term, structurally compliant bonding into a near-wellbore region.

Another example of prior art includes International Patent Application Publication No. WO2019/09725121A2, filed by applicant BISN Tec LTD. The publication discloses an expandable eutectic alloy based downhole tool and methods of deploying the downhole tool. Specifically, the publication discloses technology called WellLock, which is a thermite activated Bismuth and Tin metal plug aiming at traversing the wellbore with a liquid metal that solidifies after removal of heat from the Bismuth/Tin mixture. However, this product does not address any need for long-term, structurally compliant bonding into a near-wellbore region.

Therefore, a need exists for creating permanent fluid seals (e.g., formation-to-formation seals) within wellbores (e.g., across the caprock) extending through or within reservoirs, which contain injected fluids or other downhole fluids, wherein the installation and creation of the permanent seals prevent migration of the downhole fluids and their by-products into the surrounding environment and up to the surface.

A need also exists for creating permanent fluid seals (e.g., formation-to-formation seals) within wellbores (e.g., across the caprock) extending through or within reservoirs, which are used for CO₂ sequestration, such as within Woodford shale and Anahuac shale regions. The Woodford shale and Anahuac shale regions are the cap rock regions that are encountered in many oil and gas projects on land, as well as in the Gulf of Mexico.

A need also exists for sealing materials (e.g., alloy compositions) that can create a permanent seal within and across the cap rock located above a saturated carbonic acid (H₂CO₃) environment, wherein the permanent seal is impervious to carbon dioxide (CO₂) and carbonic acid (H₂CO₃).

Embodiments usable within the scope of the present disclosure meet these needs.

### BRIEF DESCRIPTION OF THE DRAWINGS

In the detailed description of various embodiments usable within the scope of the present disclosure, presented below, reference is made to the accompanying drawings, in which:

FIG. 1 depicts a schematic view of a wellsite system comprising an apparatus usable within the scope of the present disclosure.

FIGS. 2-5 depict schematic sectional views of a portion of the wellsite system shown in FIG. 1 with the apparatus in different stages of operations within the scope of the present disclosure.

FIG. 6 depicts a schematic sectional view of a portion of the wellsite system shown in FIG. 1 comprising a different apparatus usable within the scope of the present disclosure.

FIGS. 7-10 depict schematic sectional views of a portion of the wellsite system shown in FIG. 1 with a different apparatus in different stages of operations within the scope of the present disclosure.

FIGS. 11-14 depict schematic sectional views of different embodiments of the apparatus shown in FIGS. 7-10.

FIGS. 15-17 depict schematic sectional views of a portion of the wellsite system shown in FIG. 1 with a different apparatus in different stages of operations within the scope of the present disclosure.

FIG. 18 depicts a schematic sectional view of a portion of the wellsite system shown in FIG. 1 with a different apparatus in a different stage of operations within the scope of the present disclosure.

FIG. 19A depicts a cross-sectional view of an embodiment of an apparatus usable within the scope of the present disclosure.

FIG. 19B depicts a cross-sectional view of an alternate embodiment of the apparatus of FIG. 19A.

FIG. 20A depicts a cross-sectional view of an embodiment of an apparatus usable within the scope of the present disclosure.

FIG. 20B depicts a cross-sectional view of an alternate embodiment of the apparatus of FIG. 20A.

FIG. 21A depicts a cross-sectional view of an embodiment of an apparatus usable within the scope of the present disclosure.

FIG. 21B depicts a cross-sectional view of an alternate embodiment of the apparatus of FIG. 21A.

FIG. 22A depicts an isometric, partial cross-sectional view of an embodiment of an apparatus usable within the scope of the present disclosure.

FIG. 22B depicts a diagrammatic end view of the apparatus of FIG. 22A.

FIG. 22C depicts an isometric, partial cross-sectional view of the apparatus of FIG. 22A, having a cap engaged therewith.

One or more embodiments are described below with reference to the listed Figures.

### DETAILED DESCRIPTION OF THE EMBODIMENTS

Before describing selected embodiments of the present disclosure in detail, it is to be understood that the present invention is not limited to the particular embodiments described herein. The disclosure and description herein is illustrative and explanatory of one or more presently preferred embodiments and variations thereof, and it will be appreciated by those skilled in the art that various changes in the design, organization, means of operation, structures and location, methodology, and use of mechanical equivalents may be made without departing from the spirit of the invention.

As well, it should be understood that the drawings are intended to illustrate and plainly disclose presently preferred embodiments to one of skill in the art, but are not intended to be manufacturing level drawings or renditions of final products and may include simplified conceptual views to facilitate understanding or explanation. Also, the relative size and arrangement of the components may differ from that shown and still operate within the spirit of the invention.

Moreover, it will be understood that various directions such as “upper”, “lower”, “bottom”, “top”, “left”, “right”, and so forth are made only with respect to explanation in conjunction with the drawings, and that components may be oriented differently, for instance, during transportation and manufacturing as well as operation. Because many varying and different embodiments may be made within the scope of the concept(s) herein taught, and because many modifications may be made in the embodiments described herein, it is to be understood that the details herein are to be interpreted as illustrative and non-limiting.

Embodiments of the present invention are usable to facilitate abandonment of a well by installing a plug within a wellbore and fusing, or otherwise bonding, the plug to the sidewall of the wellbore to permanently seal the wellbore in a manner that prevents or inhibits leaking of downhole fluids (e.g., liquids and/or gases) into the surrounding environment and/or in an uphole direction, including past the plug. For example, the present invention will allow for the in-situ creation of a competent formation-integrated plug that is fused with a sidewall of a wellbore, which acts as a cap rock and is impervious to harmful and corrosive products and by-products of migrating downhole fluids. Such a sealing mechanism involves generating a chemically inert, structurally compliant, long-term bond between the plug and the wellbore sidewall.

Embodiments of the present invention include: (1) the use of wellbore plugs as well plugs and (2) the installation of these wellbore plugs within a wellbore to permanently seal the wellbore in a manner that prevents or inhibits leaking of downhole fluids into the surrounding environment and in an uphole direction, past the wellbore plugs.

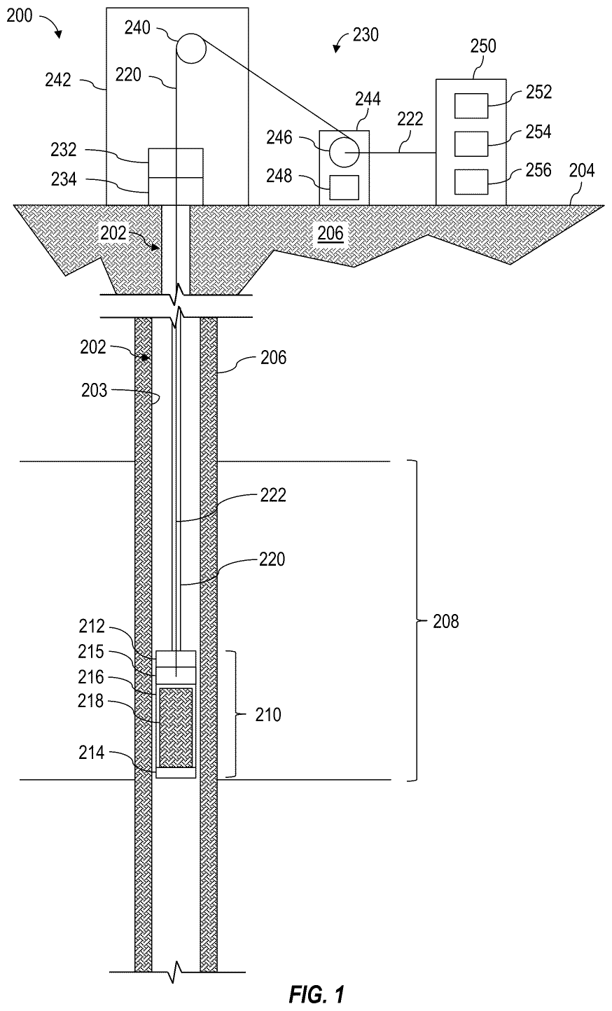

FIG. 1 is a schematic view of at least a portion of an exemplary embodiment of a wellsite system 200 according to one or more aspects of the present disclosure, representing an environment in which one or more aspects of the present disclosure may be implemented. The wellsite system 200 is depicted in relation to a wellbore 202 formed by rotary and/or directional drilling and extending from a wellsite surface 204 into a subterranean formation 206, including through a cap rock zone (or layer) 208 of the subterranean formation 206. The wellsite system 200 may have been utilized to facilitate recovery of oil, gas, and/or other materials that were trapped in the subterranean formation 206 via the wellbore 202. A lower portion of the wellbore 202 is shown enlarged, as compared to an upper portion of the wellbore 202 that is adjacent the wellsite surface 204. The enlargement permits a more detailed depiction of various tools, including tubulars, devices, and other objects, which are disposed within the wellbore 202.

At least a portion of the wellbore 202 may be a cased-hole wellbore 202 that comprises a casing (not shown) secured by cement (not shown). At least a portion of the wellbore 202 may also, or instead, be an open-hole wellbore 202 lacking the casing and cement. Thus, one or more aspects of the present disclosure are applicable to and/or readily adaptable for utilizing in a cased-hole portion of the wellbore 202 and an open-hole portion of the wellbore 202. It is also noted that although the wellsite system 200 is depicted as an onshore implementation, it is to be understood that the aspects described below are also generally applicable to offshore implementations.

The wellsite system 200 includes surface equipment 230 located at the wellsite surface 204. The wellsite system 200 also includes or is operable in conjunction with a downhole intervention tool and/or a sensor assembly, referred to as a tool string 210, conveyed within the wellbore 202 along the subterranean formation 206 via a conveyance line 220, which is operably connected with one or more pieces of the surface equipment 230. The conveyance line 220 may be operably connected with a conveyance device 240 that is operable to apply an adjustable downward- and/or upward-directed force to the tool string 210 via the conveyance line 220 to convey the tool string 210 within the wellbore 202. The conveyance line 220 may be, or can comprise coiled tubing, a cable, a wireline, a slickline, a multiline, or an e-line, among other examples. The conveyance device 240 may be, or can comprise, or can form at least a portion of a sheave or pulley, a winch, a draw-works, an injector head, and/or other device coupled to the tool string 210, via the conveyance line 220. The conveyance device 240 may be supported above the wellbore 202 via a mast, a derrick, a crane, and/or other support structure 242. The surface equipment 230 may further comprise a reel or drum 246 that can be configured to store thereon a wound length of the conveyance line 220, which may be selectively wound and unwound by the conveyance device 240 to selectively convey the tool string 210 into, along, and out of the wellbore 202. Instead of or in addition to the conveyance device 240, the surface equipment 230 may comprise a winch conveyance device 244 comprising or operably connected with the drum 246. The drum 246 may be rotated by a rotary actuator 248 (e.g., an electric motor) to selectively unwind and wind the conveyance line 220 to apply an adjustable tensile force to the tool string 210, to selectively convey the tool string 210 into, along, and out of the wellbore 202.

The conveyance line 220 may comprise metal tubing, support wires (e.g., armor wires), and/or cables configured to support the weight of the downhole tool string 210. The conveyance line 220 may also comprise one or more insulated electrical and/or optical conductors 222 operable to transmit electrical energy (i.e., electrical power) and electrical and/or optical signals (e.g., sensor data, control data) between the tool string 210 and one or more components of the surface equipment 230, such as a power and control system 250. The conveyance line 220 may comprise and/or be operable in conjunction with a means for communication between the tool string 210, the conveyance device 240, the winch conveyance device 244, and/or one or more other portions of the surface equipment 230, including the power and control system 250. Such communication apparatus may include surface and downhole communication (i.e., telemetry) devices, operatively connected with the conveyance line 220.

A wellhead 234 may cap the upper (or surface) end of the wellbore 202. A plurality (e.g., a stack) of fluid control devices 232 may be mounted on top of the wellhead 234. The fluid control devices 232 may include fluid control valves, spools, and fittings individually and/or collectively operable to direct and control the flow of fluid out of the wellbore 202. The tool string 210 may be deployed into or retrieved from the wellbore 202 via the conveyance device 240 and/or winch conveyance device 244 through the fluid control devices 232 and the wellhead 234.

The power and control system 250 (e.g., a control center) may be utilized to monitor and control various portions of the wellsite system 200. The power and control system 250 may be located at the wellsite surface 204 or on a structure located at the wellsite surface 204. However, the power and control system 250 may instead be located at a remote location from the wellsite surface 204. The power and control system 250 may include a source of electrical power 252, a control workstation 254 (i.e., a human machine interface (HMI)), and a surface controller 256 (e.g., a processing device or computer). The surface controller 256 may be communicatively connected with various equipment of the wellsite system 200, such that it may permit the surface controller 256 to monitor operations of one or more portions of the wellsite system 200 and/or provide control of one or more portions of the wellsite system 200, including the tool string 210, the conveyance device 240, and/or the winch conveyance device 244. The control workstation 254 may be communicatively connected with the surface controller 256, and the control workstation 254 may include input devices for receiving the control data (e.g., control commands) from human wellsite personnel and output devices for displaying sensor data (e.g., sensor measurements) to the human wellsite personnel. The surface controller 256 may be operable to receive and process the sensor data from the tool string 210 and/or control data entered to the surface controller 256 by the human wellsite personnel via the control workstation 254. The surface controller 256 may store executable computer programs and/or instructions and may be operable to implement or otherwise cause one or more aspects of methods, processes, and operations, described herein, based on the executable computer programs, the received sensor data, and the received control data.

The tool string 210 may comprise one or more downhole tools (e.g., tool string portions, modules, subs, devices, etc.). The downhole tools may include a cable head 212 operable to connect with the conveyance line 220. The cable head 212 may physically and/or electrically connect the conveyance line 220 with the tool string 210, such that the cable head 212 may permit the tool string 210 to be suspended and conveyed within the wellbore 202 via the conveyance line 220. The downhole tools include a wellbore plug delivery apparatus 216 for containing (or holding) and conveying a wellbore plug (or a rock formation core) 218 within the wellbore 202 to a predetermined depth within the wellbore 202. The downhole tools may also include a holding apparatus 214 configured to engage a sidewall 203 of the wellbore 202 and hold or otherwise support the wellbore plug 218 at the predetermined depth.

The wellsite system 200, including the tool string 210, may be operable to perform at least a portion of wellbore sealing operations to permanently seal the wellbore 202. The wellbore sealing operations may include inserting and conveying a plurality of wellbore plugs 218 within the wellbore 202 to a predetermined depth via the wellbore plug delivery apparatus 216. Each wellbore plug 218 may be positioned within an open (i.e., uncased) portion of the wellbore 202 at the predetermined depth, such that the wellbore plugs 218 are disposed along the rock formation 206 forming the sidewall 203 of the wellbore 202. For example, the wellbore plugs 218 may be positioned within and sealed against a cap rock zone 208 of the rock formation 206 defining the wellbore 202.

The wellbore plug delivery apparatus 216 may comprise a thin-walled tubular body having or defining an axial chamber 217 (e.g., a bore) configured to accommodate the wellbore plug 218 therein. The wellbore plug delivery apparatus 216 may instead comprise a cylindrical cage (or basket) having or defining an open area configured to accommodate the wellbore plug 218 therein. The wellbore plug delivery apparatus 216 may be formed from disintegrable materials (e.g., paper, a soft metal, a polymer, etc.) that can be burned, melted, destroyed, disintegrated, or otherwise eradicated by high temperatures generated by an exothermic reaction during bonding operations to permanently seal the wellbore 202, as described below. The wellbore plug delivery apparatus 216 may connect the wellbore plug 218 directly to the conveyance line 220 or indirectly via the cable head 212. The wellbore plug delivery apparatus 216 and the wellbore plug 218 may therefore be deployed and conveyed within the wellbore 202 from the wellsite surface 204, via the conveyance line 220. After the wellbore plug 218 is conveyed within the wellbore 202 to the predetermined depth, the wellbore plug 218 may be held or otherwise maintained in the predetermined depth by the holding apparatus 214.

The holding apparatus 214 may be connected to or otherwise carried by the wellbore plug delivery apparatus 216 below the wellbore plug 218. The holding apparatus 214 may be conveyed in a disengaged (e.g., retracted) position, such that it can be conveyed downhole to the predetermined depth, and then operated from the wellsite surface 204 (e.g., by applying tension or via the power and control system 250 and the conductor 222) to an engaged (e.g., extended) position to engage the sidewall 203 of the wellbore 202 to therefore prevent or inhibit movement of the holding apparatus 214, and thus the wellbore plug 218, along the wellbore 202. The holding apparatus 214 may be, or can comprise, for example, an expandable (e.g., inflatable) device, such as a plug or a packer. The holding apparatus 214 may instead be conveyed in a partially engaged position, in which at least a portion (e.g., a spring-loaded latch) of the holding apparatus 214 contacts (e.g., slides along) the sidewall 202 of the wellbore 202, allowing the holding apparatus 214, and thus the tool string 210, to be freely conveyed downhole along the wellbore 202 to the predetermined depth. The tool string 210, and thus the holding apparatus 214, may then be pulled in an uphole direction from the wellsite surface 204, via the conveyance line 220, to cause the holding apparatus 214 to fully engage the sidewall 203 of the wellbore 202 to prevent or inhibit movement of the holding apparatus 214, and thus the wellbore plug 218, along the wellbore 202. The holding apparatus 214 may be or comprise, for example, a spring-loaded folding (e.g., fan-shaped) basket, a cement retainer basket (cement hanger), or a J-latch apparatus.

The holding apparatus 214 may be further configured to close off the area (or space) between the wellbore plug 218 and the rock formation 206 of the wellbore 202, thereby forming a temporary fluid (and pressure) barrier between the wellbore plug 218 and the rock formation 206 below an annular space (or gap) 266 defined between the wellbore plug 218 and the rock formation 206. The holding apparatus 214 may be configured to centralize the wellbore plug 218 within the wellbore 202, such as by engaging with the sidewall 203 of the wellbore 202, as described above.

Although the holding apparatus 214 and the wellbore plug delivery apparatus 216 are described above as being conveyed downhole together as part of a single tool string 210, the holding apparatus 214 may instead be conveyed within the wellbore 202 from the wellsite surface 204 via the conveyance line 220 to the predetermined depth by itself and, then, operated to engage the sidewall 202 of the wellbore 202 such that the holding apparatus 214 is maintained at the predetermined depth. The holding apparatus 214 may be operated from the wellsite surface 204 via the power and control system 250, or by pulling on the conveyance line 220 from the wellsite surface 204 to cause the holding apparatus 214 to engage the sidewall 202 of the wellbore 202. The wellbore plug delivery apparatus 216 can be deployed thereafter and conveyed within the wellbore 202 from the wellsite surface 204, via the conveyance line 220, to the predetermined depth for positioning the wellbore plug 218 onto the holding apparatus 214, such that the holding apparatus 214 supports the wellbore plug 218.

After the wellbore plug 218 is positioned and held at the predetermined depth within the wellbore 202, the wellbore plug delivery apparatus 216 may be operated from the wellsite surface 204, via the power and control system 250 or by pulling on the conveyance line 220 from the wellsite surface 204, to detach the wellbore plug delivery apparatus 216 from the holding apparatus 214. Thereafter, wellbore plug delivery apparatus 216 may be retrieved to the wellsite surface 204 via the conveyance line 220.

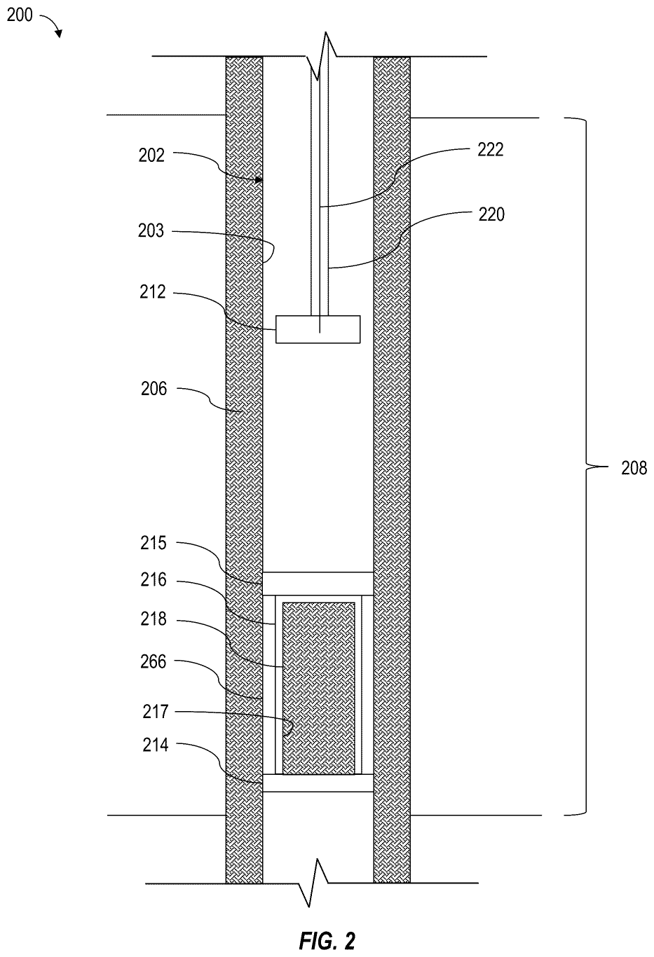

FIG. 2 is a schematic sectional view of a portion of the wellsite system 200 shown in FIG. 1 in a subsequent stage of the wellbore sealing operations to permanently seal the wellbore 202.

As shown, after the wellbore plug 218 is positioned and held at the predetermined depth within the wellbore 202, the wellbore plug delivery apparatus 216 may instead remain downhole at the predetermined depth, and the cable head 212 may be retrieved to the wellsite surface 204 via the conveyance line 220.

The wellbore plug delivery apparatus 216 may be connected to the holding apparatus 214 such that pulling on the conveyance line 220 from the wellsite surface 204 causes the cable head 212 to disconnect from the wellbore plug delivery apparatus 216, or another portion of the tool string 210, allowing the cable head 212 to be retrieved to the wellsite surface 204. The wellbore plug delivery apparatus 216 may instead comprise an engagement apparatus 215 configured to engage the sidewall 202 of the wellbore 202, such that the wellbore plug delivery apparatus 216 is maintained at the predetermined depth and pulling on the conveyance line 220 from the wellsite surface 204 causes the cable head 212 to disconnect from the wellbore plug delivery apparatus 216 or another portion of the tool string 210, allowing the cable head 212 to be retrieved to the wellsite surface 204. The engagement apparatus 215 may be operated from the wellsite surface 204 via the power and control system 250 or by pulling on the conveyance line 220 from the wellsite surface 204 to cause the engagement apparatus 215 to engage the sidewall 203 of the wellbore 202 to prevent or inhibit movement of the engagement apparatus 215, and thus the wellbore plug delivery apparatus 216, along the wellbore 202. The engagement apparatus 215 may be or can comprise, for example, an expandable (e.g., inflatable) device, such as a plug or a packer. The engagement apparatus 215 may instead be conveyed in partially engaged position, in which at least a portion (e.g., a spring-loaded latch) of the engagement apparatus 215 contacts (e.g., slides along) the sidewall 202 of the wellbore 202, allowing the engagement apparatus 215, and thus the tool string 210, to be freely conveyed downhole along the wellbore 202 to the predetermined depth. Pulling on the conveyance line 220 from the wellsite surface 204 may cause the engagement apparatus 215 to fully engage the sidewall 202 of the wellbore 202. The engagement apparatus 215 may be further configured to centralize the wellbore plug 218 within the wellbore 202, such as by engaging with the sidewall 203 of the wellbore 202, as described above. The engagement apparatus 215 may thus be or can comprise, for example, an expandable (e.g., inflatable) device, such as a plug or a packer. The engagement apparatus 215 may instead be or comprise one or more radially extending spring-loaded latches (e.g., upward pointing fingers or wedges) or swab cups.

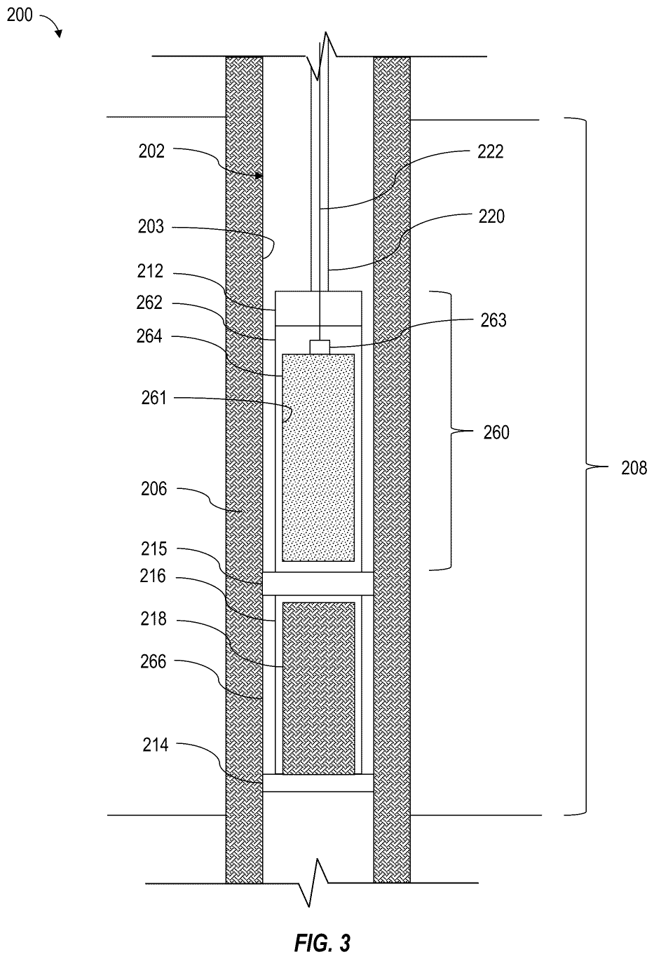

FIG. 3 is a schematic sectional view of a portion of the wellsite system 200 shown in FIGS. 1 and 2 in a subsequent stage of the wellbore sealing operations to permanently seal the wellbore 202.

As shown, after a wellbore plug 218 is positioned and held at the predetermined depth within the wellbore 202, another downhole tool string 260 may be deployed within the wellbore 202. The another downhole tool string 260 may comprise a sealing material delivery apparatus 262 containing sealing material (or a mixture of sealing materials) 264 for fusing or otherwise bonding together the wellbore plug 218 and the rock formation 206 to seal the wellbore 202. The sealing material delivery apparatus 262 may comprise a tubular body having or defining an axial chamber 261 (e.g., a bore) configured to accommodate the sealing material 264 therein. The another downhole tool string 260 may be conveyed downhole to the wellbore plug 218 until the sealing material delivery apparatus 262 contacts or is in close proximity to the wellbore plug 218, thereby delivering the sealing material 264 to the wellbore plug 218. The wellbore sealing operations may further comprise bonding operations to bond together the wellbore plug 218 and the rock formation 206 defining the wellbore 202, with the use of sealing material 264 to permanently seal the wellbore 202.

The sealing material delivery apparatus 262 may be configured to contain and isolate the sealing material 264 from the wellbore environment, including wellbore fluid, as the sealing material delivery apparatus 262 is conveyed within the wellbore 202. The sealing material delivery apparatus 262 may further comprise an igniter 263 operable to ignite the sealing material 264 to initiate an exothermic reduction-oxidation (“redox”) reaction (also known as the Goldschmidt reaction, and hereinafter “exothermic reaction”) of the sealing material 264, thereby initiating the bonding operations to bond together the wellbore plug 218 and the rock formation 206 to seal the wellbore 202, as described below. The sealing material delivery apparatus 262 may be at least partially consumed while the sealing material 264 undergoes the exothermic reaction. During an exothermic reaction, the ignited sealing material 264 generates a high temperature heat and produces a molten (or viscous) sealing material 274, which can flow from the sealing material delivery apparatus 262 into the annular space 266 and contact the outer surface of the wellbore plug 218 and the inner surface (or the sidewall 203) of the rock formation 206 of the wellbore 202, between the wellbore plug 218 and the rock formation 206.

The sealing material delivery apparatus 262 may therefore be configured to discharge the molten sealing material 274, while undergoing the exothermic reaction, into the annular space 266 defined between the outer surface of the wellbore plug 218 and the inner surface (i.e., the sidewall 203) of the rock formation 206 of the wellbore 202 to therefore bond together the wellbore plug 218 and the rock formation 206 along the cap rock zone 208.

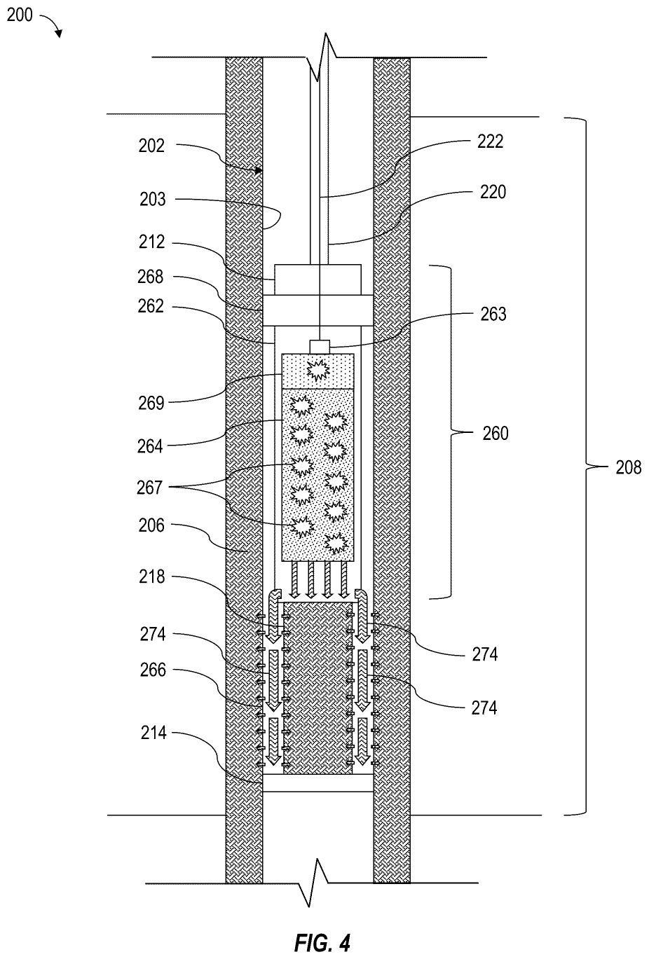

FIG. 4 is a schematic sectional view of a portion of the wellsite system 200 shown in FIGS. 1-3 in a subsequent stage of the wellbore sealing operations, including bonding operations to bond the wellbore plug 218 and the rock formation 206 of the wellbore 202, to permanently seal the wellbore 202.

As shown, during the bonding operations, after the igniter 263 ignites the sealing material 264, the sealing material delivery apparatus 262 discharges and directs the flow of the molten sealing material 274 into the annular space 266. As the high-temperature molten sealing material 274 flows through the annular space 266, the sealing material 274 flows into cracks, fissures, fractures, and/or other interstitial voids extending into the wellbore plug 218 and the rock formation 206 of the wellbore 202 (e.g., within the near wellbore region of the rock formation). The high-temperature molten sealing material 274 melts a portion of the wellbore plug 218 and the rock formation 206 of the wellbore 202 to a certain depth below their respective surfaces, resulting in a mixing of the molten sealing material 274 with the molten wellbore plug 218 and the rock formation 206. The holding apparatus 214 can prevent or inhibit the molten sealing material 274 from flowing out of the annular space 266 into the wellbore 202, below the wellbore plug 218. After the sealing material 274 is fully discharged from the sealing material delivery apparatus 262 into the annular space 266, the sealing material delivery apparatus 262 may be retrieved to the wellsite surface 204 via the conveyance line 220.

The sealing material 264 may be or can comprise a thermite-based material (i.e., a thermite or thermite mixture) comprising ingredients configured to undergo an exothermic reaction 267 after being ignited by the ignitor 263. The thermite-based material can include a metal fuel (e.g., a metal, such as aluminum, or a metal powder) and an oxidizer (e.g., a metal oxidizer, such as iron oxide). Other examples of metals that can be used are magnesium, titanium, zinc, silicon, and boron. In addition, metal alloys, such as Inconel, Monel, chrome, and/or carbon steel metallurgicals, can be used in thermite-based material. Alternatively, a pseudo-metal and oxidizer may be used to form the thermite-based material, such as silicon dioxide (silica) or bismuth.

The sealing material 264 may be an integrated-chemistry thermite bonding mixture having a specific formulation that can fuse or otherwise bond together the wellbore plugs 218 and the rock formation 206 of the wellbore 202 to permanently seal the wellbore 202. The scaling material 264 may be formulated based on one or more considerations, which include: the in-situ geology features of the wellbore plugs 218, the composition of the rock formation 206 of the wellbore 202, the well apparatus (e.g., presence of casing, production tubulars, and/or cement) that may remain within the wellbore 202 and the state of such well apparatus, the composition of fluids within the wellbore 202, the composition of the surrounding rock formation 206, and any fluid barrier requirements (e.g., regulations) that may be in force. Thus, the formulation (e.g., chemistry, make-up) of the sealing material 264 may be a thermite or thermite mixture comprising a metal and an oxidizer or a pseudo-metal and oxidizer, which may depend on formulation or make-up of the wellbore plug 218 and the rock formation 206 at the seal zone (e.g., along the cap rock zone 208) of the wellbore 202. The formulation of the sealing material 264 may therefore be a boutique mixture of ingredients that offers specific post-reaction felicity and barrier strength to resist lower zone pressure, agents (e.g., wellbore fluids) of corrosive capacity, and geologic shifting.

The sealing material 264 may comprise a mixture of sealing materials that include reagents that react to generate a by-product material, which is physically compatible to the downhole bonding requirements for full downhole seal capability. The mixture of materials forming the sealing material 264 may comprise a metal, a pseudo-metal, a metal oxide or other oxidizer, and a reduction agent. An exemplary downhole environment (or complex) includes a wellbore 202 that is free of steel-type tubular relics and comprises an open-hole geometry that has a simple limestone caprock barrier. The reagent chemistry of the sealing material 264 compatible with such an environment may be formulated to: a) undergo a molten (thermitic) transition prior to being driven into the limestone; b) chemically bond with mechanical felicity such that a stable inter-molecular bond is generated; and c) by using the volume remaining within the “open-hole” void between the wellbore plugs 218 and the rock formation 206 of the wellbore 202, present a physical barrier with non-conciliatory behavior to pressure, immunity to chemical attacks, and long-term physical uniaxial and multiaxial strength.

An exemplary downhole environment (or complex) that may be difficult to traverse can include a wellbore 202 containing a chrome-based liner pipe that is cemented to a shale caprock, which includes layers of siliceous cement bonded to a “cemented” drill mud and shale near-wellbore damage zone, followed by virgin shale caprock. The chemistry of the sealing material 264 compatible with an environment containing and configured to integrate metal, cement, mud, and shale, and having drive dynamics in the molten (or viscous) state with additional final pressure barrier and sequestration material (e.g., carbon dioxide and hydrogen sulfide) immunity may be selected to be compatible with such an environment.

The ingredients of the sealing material 264 may be complimentary with (i.e., having felicity to) the geological makeup of the wellbore plug 218 and the rock formation 206, and may include constituent chemicals of the wellbore plug 218 and the rock formation 206, such as, Opalinus clays, Anahuac shale, and/or Morrow B sandstone. Chemical compatibility, specificity, and integrated residence into physically sound cap rock zone(s) 208 of the sealing material 264 may allow cohesion via coordinated bonding at an atomic level (i.e., specificity) and maintenance of capacity for migration and/or saturation into sealable, non-patent rock formation (i.e., soundness). The sealing material 264 may be, or can comprise, a thermite mixture that comprises a family of metals and/or pseudo-metals and oxidizers that are capable of undergoing an exothermic reaction and generating an atomic-level (or chemical) bond with the rock formation 206, along the cap rock zone 208 and casing or other in-situ metallurgical material. Thus, the sealing material 264 may comprise constituent chemicals that are compatible with (or otherwise based on): (1) the geological makeup of the cap rock zone 208, (2) the architecture of the wellbore 202 (including materials and/or devices located within the wellbore), (3) a well-drill physical status, and (4) the likely or planned potential saturations from natural formation regurgitation and migratory species from the secondary saturation from injection wells.

The sealing material 264 may comprise bonding material ingredients configured to form a bonding material (i.e., a bonding agent) when heated during the exothermic reaction. The bonding material bonds with the constituent chemicals forming the wellbore plug 218 and the rock formation 206, such that upon cooling and solidification (or curing) of the molten sealing material 274, wellbore plug 218, and rock formation 206, the bonding material fuses or otherwise bonds together the wellbore plug 218 and the rock formation 206 of the wellbore 202 to permanently seal the wellbore 202. In other words, as the molten sealing material 274 cools and solidifies, the bonding material operates as a matrix, bonding with the constituent chemicals of the wellbore plug 218 and the rock formation 206, thereby bonding together the wellbore plug 218 and the rock formation 206. The bonding material forms a molecular (or chemical) bond with the wellbore plug 218 and the rock formation 206. The bonding material also forms physical (or mechanical) bond with the wellbore plug 218 and the rock formation 206 because the molten bonding material enters and solidifies within the interstitial voids extending into the wellbore plug 218 and the rock formation 206 of the wellbore 202, thereby operating as physical anchors to the wellbore plug 218 and rock formation 206.

The constituent chemicals (or composition) of the wellbore plug 218 may be the same as or similar to (i.e., chemically compatible with) the constituent chemicals (or composition) of the rock formation 206 and/or the metal fuel. The constituent chemicals of the rock formation 206 of the cap rock zone 208 may comprise a clay (e.g., Opalinus clay), a shale (e.g., Anahuac shale), and/or a sandstone (e.g., Morrow B sandstone). Thus, the constituent chemicals (or composition) of the wellbore plug 218 may also comprise a clay (e.g., Opalinus clay), a shale (e.g., Anahuac shale), a sandstone (e.g., Morrow B sandstone), and/or other materials that are compatible with the rock formation 206 and/or the metal fuel.

The sealing material 264 may further comprise additional ingredients that are complimentary with (i.e., having felicity to) the geological makeup of the wellbore plug 218 and the rock formation 206, such as constituent particles (e.g., powder, granules, etc.) having a composition that is the same or similar to (i.e., chemically compatible with) the composition of the wellbore plug 218, the rock formation 206, and/or the metal fuel. For example, the constituent particles may comprise constituent chemicals forming the wellbore plug 218 and the rock formation 206, such as a clay (e.g., Opalinus clay), a shale (e.g., Anahuac shale), sandstone (e.g., Morrow B sandstone), and/or other materials that are compatible with the wellbore plug 218, the rock formation 206, and/or the metal fuel. Thus, as the molten sealing material 274 cools and solidifies, the bonding material operates as a matrix, bonding with the constituent chemicals of the wellbore plug 218, the rock formation 206, and the constituent particles, thereby bonding together the wellbore plug 218, the rock formation 206, and the constituent particles. The bonding material forms a molecular (or chemical) bond with the wellbore plug 218, the rock formation 206, and the constituent particles. The bonding material also forms physical (or mechanical) bond with the wellbore plug 218, the rock formation 206, and the constituent particles, while limiting the presence or creation of occlusions or slip deformations in the physical plug solid matrix.

The exothermic reaction 267, including: (1) the flow of the molten sealing material 274 from the sealing material delivery apparatus 262, (2) the melting of the wellbore plug 218 and rock formation 206, and (3) the cooling and solidification of the molten sealing material 274 (including the bonding material), wellbore plug 218, and rock formation 206 to bond together the wellbore plug 218 and rock formation 206, is referred to herein collectively as the bonding operations. Also, the solidified (or cured) bonding material 264 and the constituent particles is referred to herein collectively as a sealing composite material 265.

The sealing material 264 may also be formulated such that the analyzed downhole hazards, including chemical attacks or degradation, are rendered inert. Constituent chemicals of the wellbore plug 218 and the rock formation 206 often have a high resistance to chemical attacks and degradation. Accordingly, adding constituent chemicals of the wellbore plug 218 and the rock formation 206 to the sealing material 264 may result in the sealing composite material 265 being highly reluctant to chemical attacks or degradation. For example, adding constituent particles comprising constituent chemicals of the wellbore plug 218 and the rock formation 206 to the sealing material 264 may result in the sealing composite material 265 being highly reluctant to chemical attacks or degradation.

The sealing material 264 may be or may comprise a thermite or thermite mixture (e.g., a metal and oxidizer or a pseudo-metal and oxidizer) comprising the constituent chemicals of the wellbore plug 218 and the rock formation 206. The thermite or thermite mixture is capable of undergoing an exothermic reaction that increases the temperature of all components of the sealing material 264, forming a molten sealing material 274 that contacts and partially melts the wellbore plug 218 and the rock formation 206.

As indicated above, the sealing material 264 may comprise bonding material ingredients configured to form a bonding material (i.e., a bonding agent) when heated during the exothermic reaction. Bonding material ingredients may comprise a derivative of a pseudo-metal, such as a pseudo-metal oxidizer that can provide oxygen to a metal fuel during an exothermic reaction of the bonding material 264 while also producing a molten bonding material. An example pseudo-metal oxidizer may be silicon dioxide (SiO₂) (also known as silica). During an exothermic reaction, silicon dioxide can give up the oxygen molecule and result in (or produce) molten silicon, which is a bonding material that has a high bond strength to fuse or otherwise bond with certain chemicals, such as the constituent chemicals of the wellbore plug 218 and the rock formation 206. As the molten sealing material 274 (including the molten bonding material) cools and solidifies (or cures), the bonding material can bond with the constituent chemicals of the wellbore plug 218 and the rock formation 206, thereby bonding together the wellbore plug 218, the rock formation 206, and constituent particles.

As described herein, the integration of the sealing material 264 with the wellbore plugs 218 and the rock formation 206 forming the wellbore 202 is facilitated by the capacity of the sealing material 264 to reach a molten (or viscous) state during an exothermic reaction 267. As further described above, the molten sealing material 274 may be gravity driven to diffuse between and into the interstitial voids of the wellbore plugs 218 and the rock formation 206 of the wellbore 202 to facilitate the bonding (e.g., fusion, integration, etc.) of the wellbore plugs 218 and the rock formation 206. However, the molten sealing material 274 may instead be pressure-forced to diffuse between and into the interstitial voids of the wellbore plugs 218 and the rock formation 206 of the wellbore 202 to facilitate bonding (e.g., fusion, integration, etc.) of the wellbore plugs 218 and the rock formation 206. Forced diffusion of the molten sealing material 274 may include the application of pressure against the molten sealing material 274 to overcome significant gradient and entrain the molten sealing material 274 within the wellbore plugs 218 and the rock formation 206 until refusal or flow-inhibited quenching of the molten sealing material 274.

As described above, as the sealing material 264 undergoes an exothermic reaction 267, the sealing material 264 may become viscous and flow into the annular space 266 by way of gravity. However, the molten sealing material 274 may instead be pressure-forced (or pressure-driven) into and along the annular space 266 by an increased pressure formed by gases released by the sealing material 264 undergoing the exothermic reaction 267. In other words, the sealing material 264 may generate a gas during the exothermic reaction 267 to increase downhole pressure, thereby permitting the molten sealing material 274 to be pressure-forced into the annular space 266 and into the interstitial voids of the wellbore plugs 218 and the rock formation 206 of the wellbore 202. At least some of sealing material 264 may therefore be formulated to generate a gas having a pressure that exceeds the downhole hydrostatic pressure within the wellbore and is sufficient to pressure force the molten sealing material 274 against the gradients of each of the wellbore plug 218 and the rock formation 206.

The sealing material delivery apparatus 262 may be further operable to facilitate pressure isolation from an upper wellbore volume such that the molten sealing material 274 (or a sealing material 264 in a slurry state) can be pressure-forced into and along the annular space 266 between and into the wellbore plug 218 and the rock formation 206 of the wellbore 202 (e.g., along the cap rock zone 208) within the zone of penetration. For example, the sealing material delivery apparatus 262 may be configured to seal against the sidewall 203 of the wellbore 202, thereby permitting pressure to build up below the sealing material delivery apparatus 262. The scaling material delivery apparatus 262 may be configured to seal against the sidewall 203 of the wellbore 202 by an outer seal 268 configured to contact and seal against the sidewall 203. In an exemplary embodiment, the outer seal 268 may be or can comprise a packer, configured to expand to contact and seal against the sidewall 203. The outer seal 268 may instead be or can comprise a swab cup that is disposed in contact with the sidewall 203 to seal against the sidewall 203. The pressure buildup may force (or push) the molten sealing material 274 downward along the annular space 266 and into the interstitial voids of the wellbore plugs 218 and the rock formation 206 of the wellbore 202. The outer seal 268 may comprise or operate as a latching apparatus 268 that is configured to latch the tool string 260 to the sidewall 202 of the wellbore 202 to prevent or inhibit the sealing material delivery apparatus 262 from moving radially and/or axially within the wellbore 202 during the bonding operations, such as during the pressure buildup.

To increase downhole pressure to push or otherwise drive movement of the molten sealing material 274 (or a sealing material 264 in a slurry state) into and along the annular space 266 via a pressure differential, the sealing material delivery apparatus 262 may contain a drive material 269 configured to undergo an exothermic reaction 267 to increase pressure uphole from (or behind) the sealing material 264 to thereby drive (e.g., force or push) the molten sealing material 274 downward into and along the annular space 266. The drive material 269 may be one or more distinct layers of material (e.g., powder, pellets, and/or discs) located within the sealing material delivery apparatus 262. The drive material 269 may be located above the sealing material 264 and in contact with or adjacent to the sealing material 264.

The drive material 269 may comprise a thermite or thermite mixture configured to undergo an exothermic reaction. The drive material 269 may comprise a gas producing material (or gas producing thermite, e.g., metal and oxidizer with polymer or pseudo-metal and oxidizer with polymer) 269 configured to undergo an exothermic reaction and formulated to generate a gas during the exothermic reaction. The gas producing material may comprise a polymer mixed with or otherwise located in association with a thermite. An example polymer for producing gas during an exothermic reaction comprises one or more of polyethylene, polypropylene, polystyrene, polyester, polyurethane, acetal, nylon, polycarbonate, vinyl, acrylin, acrylonitrile butadiene styrene, polyimide, cylic olefin copolymer, polyphenylene sulfide, polytetrafluroethylene, polyketone, polyetheretherketone, polytherlmide, polyethersulfone, polyamide imide, styrene acrylonitrile, cellulose propionate, diallyl phthalate, and melamine formaldehyde.

The drive material 269 may be configured to undergo an exothermic reaction at a burn rate and a resulting mass flow rate that are different (e.g., higher) than the burn rate and the resulting mass flow rate of the molten sealing material 274. During the exothermic reaction, the drive material 269 may therefore be configured to result in (e.g., produce or generate) a high energy product having a high burn rate, a high mass flow rate, and/or a high temperature.

The drive material 269 may be located within the sealing material delivery apparatus 262, such that the generated gas and/or other product is discharged from the sealing material delivery apparatus 262 behind or at a later time than the molten sealing material 274 to therefore increase pressure uphole from (or behind) the molten sealing material 274 to thereby force (or push) the molten sealing material 274 downward into and along the annular space 266.

The wellbore sealing operations described above may be repeated until a uniform and adequate series of wellbore plugs 218 are installed within the wellbore 202 to permanently seal the wellbore 202 in a manner that prevents or inhibits leaking of downhole fluids in the uphole direction past the wellbore plugs 218. For example, an additional wellbore plug 218 may be inserted into the wellbore 202 and conveyed within the wellbore 202 via another wellbore plug delivery apparatus 216 supported by the conveyance line 220 until the additional wellbore plug 218 is disposed in contact or in close proximity to the previously installed wellbore plug 218. The wellbore plug delivery apparatus 216 may be then retrieved to the wellsite surface 204 via the conveyance line 220. Another sealing material delivery apparatus 262 may then be deployed within the wellbore 202 and conveyed to the additional wellbore plug 218 until the sealing material delivery apparatus 262 contacts, or is in close proximity to, the additional wellbore plug 218. The igniter 263 may ignite the sealing material 264 contained within the sealing material delivery apparatus 262, thereby initiating additional bonding operations. The sealing material delivery apparatus 262 may then direct the molten sealing material 274 into the annular space 266 between the additional wellbore plug 218 and the rock formation 206 of the wellbore 202 to fuse, or otherwise bond together, the additional wellbore plug 218 and the rock formation 206, as described above. The sealing material delivery apparatus 262 may then be retrieved to the wellsite surface 204.

Additional wellbore plugs 218 may be installed within the wellbore 202 to permanently seal the wellbore 202. Numerous wellbore plugs 218 can be used to ensure proper sealing. In an exemplary embodiment of the apparatus and methods disclosed herein, a total of one, two, three, four, five, six, or more wellbore plugs 218 may be installed within a wellbore 202 to permanently seal the wellbore 202. The wellbore plugs 218 may extend the height of the cap rock zone 208.

As described above, the molten sealing material 274 may be directed into the annular space 266 after or while the sealing material 264 undergoes an exothermic reaction 267. During the bonding operations, the sealing material 264 may instead be ignited and undergo an exothermic reaction 267 after the sealing material delivery apparatus 262 discharges and directs the molten sealing material 274 into the annular space 266. Thus, the sealing material delivery apparatus 262 can comprise a formation pump (e.g., a performance perforator). Such sealing material delivery apparatus 262 may be configured to contain a sealing material 264 in a slurry or otherwise viscous form, such that the sealing material delivery apparatus 262 can discharge and inject or otherwise direct the slurry sealing material 264 into the annular space 266, including the interstitial voids of the wellbore plug 218 and the rock formation 206 of the wellbore 202. The slurry sealing material 264 can flow into the annular space 266 by way of gravity. However, the slurry sealing material 264 may instead be pressurized to pressure force the slurry sealing material 264 into the annular space 266. As described above, the sealing material delivery apparatus 262 may pressurize the slurry sealing material 264 and discharge or inject the slurry sealing material 264 downward along the annular space 266 under pressure, thereby pressure forcing the slurry sealing material 264 into the annular space 266. The igniter may then ignite the slurry sealing material 264 to initiate an exothermic reaction 267 of the slurry sealing material 264 to therefore cause the sealing material 264 to take on a molten state to fuse or otherwise bond together the wellbore plug 218 and the rock formation 206 of the wellbore 202 to permanently seal the wellbore 202, as described herein.

The sealing material delivery apparatus 262 may be configured to generate a pressure sufficient to force (or pack) the molten or slurry sealing material 274 into the geological features of the wellbore plug 218 and the rock formation 206 of the wellbore 202 until denial, similar to injection of a fracturing fluid to fracture a rock formation. However, the pressure of the injected sealing material 274 may be such that rock break-down does not occur and the sealing material 274 only “sponge-fills” the receptive interstitial gaps, especially in the near-wellbore damaged zone of the rock formation 206 forming the wellbore 202, and including those formed during drilling operations forming the wellbore 202. The pressure generated, during the bonding operations to force the molten or slurry sealing material 274, may be determined based on the porosity of the wellbore plug 218 and the rock formation 206 of the wellbore 202. The pressure generated during the bonding operations to force the molten or slurry sealing material 274 may be determined such that the pressure is sufficient to force the molten or slurry sealing material 274 beyond a near surface damage (e.g., near wellbore damage), of the wellbore plug 218 and the rock formation 206 of the wellbore 202, to reach and bond with non-damaged portions of the wellbore plug 218 and the rock formation 206.

Furthermore, depending on the dimensions of the wellbore plug 218, it may be desirable to use multiple sealing material delivery apparatuses 262 in succession, to deliver the sealing material 264 to the wellbore plug 218 that is positioned within the wellbore 202. For example, if a single delivery of sealing material 264 is not sufficient to facilitate bonding of the wellbore plug 218 and the rock formation 206 to permanently seal the wellbore 202, such as when the annular space 266 between the wellbore plug 218 and the rock formation 206 of the wellbore 202 comprises a relatively large volume, one or more additional sealing material delivery apparatuses 262 may be conveyed within the wellbore 202 to deliver one or more additional quantities of the sealing material 264 to facilitate bonding of the wellbore plug 218 and the rock formation 206 to permanently seal the wellbore 202. Also, one or more of the additional sealing material delivery apparatuses 262 conveyed within the wellbore 202 may deliver a gas producing material 269 which, when ignited, can increase pressure uphole from (or behind) the previously delivered and injected molten scaling material 274 to thereby pressure-force (or push) the molten sealing material 274 further downhole along the annular space 266 and into interstitial voids extending into the wellbore plug 218 and the rock formation 206.

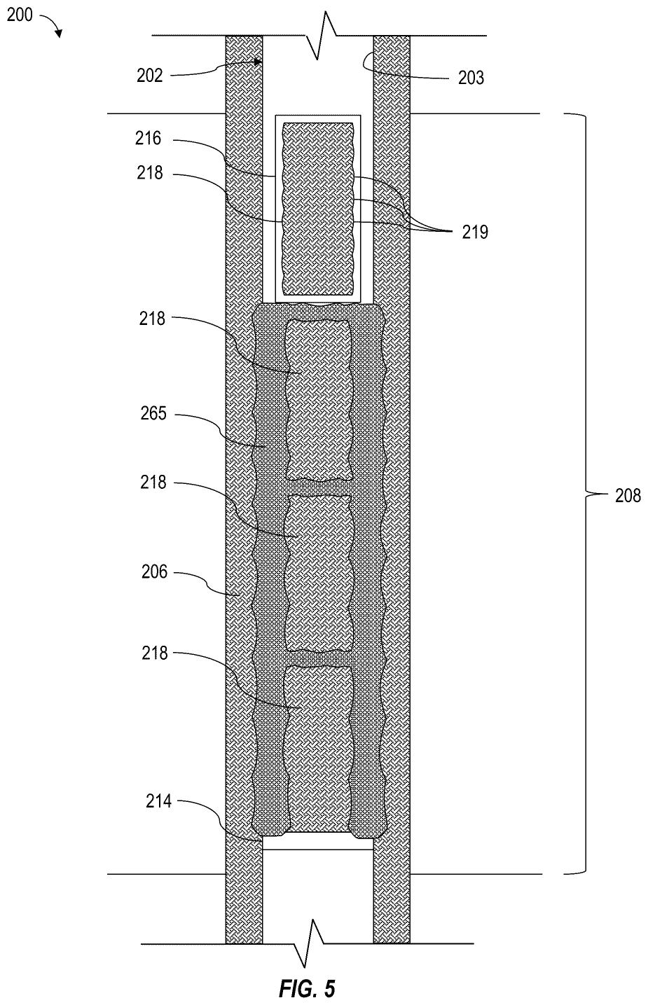

FIG. 5 is a schematic sectional view of a portion of the wellsite system 200, which is shown in FIGS. 1-4, and FIG. 5 shows a subsequent stage of the wellbore scaling operations, including bonding operations, to permanently seal the wellbore 202.

As shown, during the wellbore sealing operations, a plurality (three shown) of wellbore plugs 218 may be positioned within the wellbore 202 and bonded with the rock formation 206 via the sealing composite material 265. An additional wellbore plug 218 is shown positioned on top of the installed wellbore plugs 218 and is ready to undergo subsequent bonding operations to complete a formation-to-formation cap rock sealing bridge across the cap rock zone 208 to permanently seal the wellbore 202.

During the wellbore sealing operations, the wellbore plugs 218 are used as plugs or material fillers to facilitate permanent sealing of the wellbore 202, therefore the wellbore plugs 218 may also be referred to as plugs or material fillers. Each wellbore plug 218 may comprise a generally cylindrical configuration, having a predetermined vertical length (e.g., between about 12 and 24 inches) and a predetermined outer diameter. The outer diameter of the wellbore plugs 218 may be sized to closely match the inner diameter of the wellbore 202 (e.g., as large a diameter as possible within the wellbore), but be sufficiently smaller than the inner diameter of the wellbore 202 to permit the wellbore plugs 218 to be conveyed downhole to the predetermined depth.

Although FIGS. 1-4 show the wellbore plug 218 having a smooth circumferential outer surface, the outer surface of one or more of the wellbore plugs 218 may comprise uneven outer features 219 (e.g., undulations, circumferential grooves or ridges, projections, indentations, scuffs, etc.), as shown in FIG. 5. The uneven outer features 219 of the wellbore plugs 218 may increase the outer surface area of the wellbore plug 218 for bonding with the sidewall 203 of the rock formation 206 defining the wellbore 202. The uneven outer features 219 of the wellbore plugs 218 may facilitate increased penetration of the molten sealing material 274 into the wellbore plugs 218 during the bonding operations. The uneven outer features 219 may facilitate increased mechanical bond between the wellbore plugs 218 and the sealing composite material 265, operating as anchor points between the sealing composite material 265 and the wellbore plug 218. The uneven outer features 219 may thereby increase resistance to shear at an interface between the wellbore plugs 218 and the sealing composite material 265.

The uneven outer features 219 may facilitate a swaging (or wedging) effect between the wellbore plugs 218 and the sealing composite material 265 to radially force (or compress) the wellbore plugs 218 against the sealing composite material 265, such that the downhole pressure, trapped below the wellbore plugs 218, can apply an upwardly directed axial force to the wellbore plugs 218. Such swaging effect may close or narrow small vertical (i.e., along axis of the wellbore) spaces or gaps that may form along the interface between the wellbore plugs 218 and the sealing composite material 265, to contact seal the interface and, therefore, prevent or inhibit uphole leakage of downhole fluids past the wellbore plugs 218 along the interface. Small spaces or gaps may form along the interface when, for example, the mixture of the molten sealing material 274, wellbore plug 218, and rock formation 206 experiences shrinkage during the solidification.

Uneven inner features, which may be located along the sidewall 202 of the rock formation 206 defining the wellbore 202 (e.g., near wellbore damage caused by drilling of the wellbore 202 or by reaming or milling of a casing installed within the wellbore 202), may also facilitate a swaging (or wedging) effect between the rock formation 206 and the sealing composite material 265 to radially force (or compress) the sealing composite material 265 against the wellbore plugs 218, thereby preventing or inhibiting uphole leakage of downhole fluids past the wellbore plugs 218 and along the interface of the rock formation 206 and the sealing composite material 265.

The geological (e.g., chemical, mineral, etc.) composition the wellbore plugs 218 may be selected such that the wellbore plugs 218 are compatible with the geological (e.g., chemical, mineral, etc.) composition of the rock formation 206 through which the wellbore 202 extends. In other words, the wellbore plugs 218 may comprise a geological composition that is the same or similar to the rock formation 206 through which the wellbore 202, which is intended to be permanently sealed, extends. This similarity in the composition of the wellbore plugs 218 can result in the wellbore plugs 218 having the same or similar chemical properties (e.g., corrosion resistance) and mechanical properties (e.g., modulus of elasticity, bulk modulus, coefficient of thermal expansion, etc.) of the rock formation 206. The wellbore plugs 218 may therefore comprise a geological composition similar to the cap rock zone 208 of the rock formation 206 through which the wellbore 202, which is intended to be permanently sealed, extends. The wellbore plugs 218 may therefore be drilled or otherwise cut out of the rock formation 206 through which the wellbore 202 extends. The wellbore plugs 218 can comprise, for example, sandstone, limestone, dolomite, and/or shale. However, instead of the wellbore plugs 218 being natural wellbore plugs formed from or otherwise comprising pieces that are cut or drilled out of natural rock formation, the wellbore plugs 218 may be synthetic (e.g., manufactured, fabricated) wellbore plugs formed from a mixture of material constituents (e.g., chemical powders, pellets, and/or liquids) that, when combined and solidified (e.g., compressed and/or chemically bonded), comprise geological composition of the cap rock zone 208 of the rock formation 206 through which the wellbore 202, which is intended to be permanently sealed, extends.

As described above, the chemical composition of the sealing material 264 may be formulated such that the chemical composition of the sealing composite material 265 is the same or similar to the geological (e.g., chemical, mineral) composition of both the wellbore plugs 218 and the rock formation 206. Accordingly, the chemical properties (e.g., corrosion resistance) and the mechanical properties (e.g., modulus of elasticity, bulk modulus, coefficient of thermal expansion, etc.) of the sealing composite material 265 may be the same or similar to the chemical and mechanical properties of both the wellbore plugs 218 and the rock formation 206, resulting in an improved (e.g., stronger, less permeable, more stable) bond between the sealing composite material 265, the wellbore plugs 218, and the rock formation 206.

Although the wellbore plug delivery apparatus 216 and the sealing material delivery apparatus 262 are described herein as separate downhole tools, which are configured to be conveyed downhole successively and individually (i.e., separately) to deliver a wellbore plug 218 and a sealing material 264, it is to be understood that the wellbore plug delivery apparatus 216 and the sealing material delivery apparatus 262 may be implemented as a single downhole tool configured to deliver a wellbore plug 218 and the sealing material 264 for bonding the wellbore plug 218 to the rock formation 206 of the wellbore 202 in a single downhole conveyance.

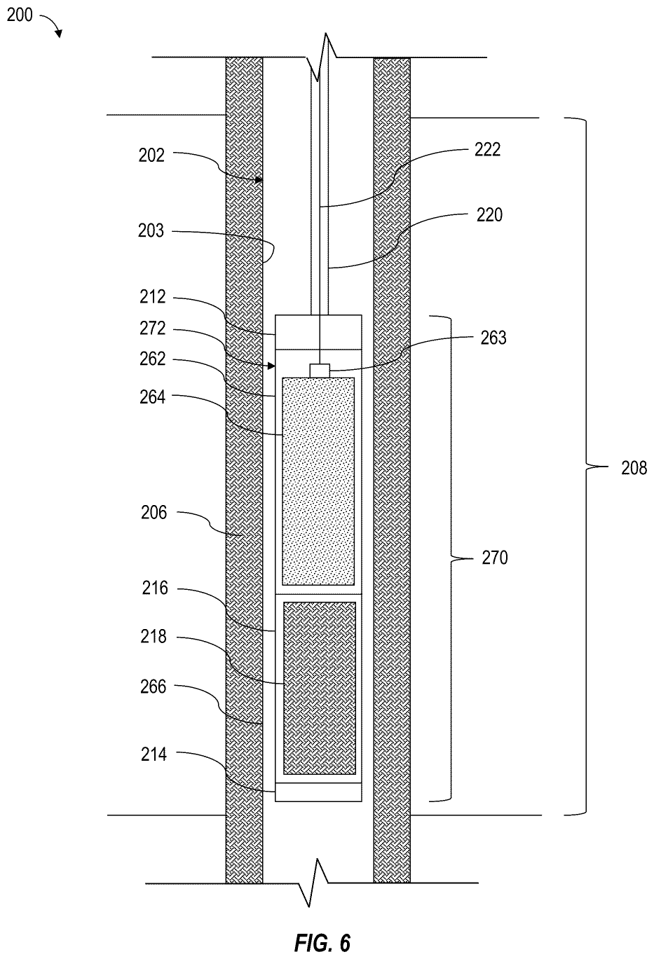

FIG. 6 is a schematic sectional view of a portion of the wellsite system 200 shown in FIGS. 1-5, comprising a tool string 270 having a combined delivery apparatus 272 operable to perform the wellbore sealing operations described herein, including the bonding operations.

The tool string 270 comprising the combined delivery apparatus 272 may have a lower section comprising a wellbore plug delivery apparatus 216 and an upper section comprising a sealing material delivery apparatus 262 may be used to perform the bonding operations. The sealing material delivery apparatus 262 of the combined delivery apparatus 272 may be disposed in contact with or in close proximity above the wellbore plug 218 located within or held by the wellbore plug delivery apparatus 216 of the combined delivery apparatus 272. The combined delivery apparatus 272 may be conveyed downhole to a predetermined depth from a wellsite surface 204, by the conveyance line 220, and held at the predetermined depth by a holding apparatus 214 until the bonding operations are complete. Successive conveyances of the combined delivery apparatus 272 may be deployed within the wellbore 202 when one or more additional wellbore plugs 218 are to be installed within the wellbore 202 to permanently seal the wellbore 202.

Although the bonding operations described herein include bonding together a wellbore plug 218 and a rock formation 206 along a sidewall 203 of the wellbore 202, it is to be understood that the bonding operations described herein include bonding together a wellbore plug 218 and other materials and/or devices (not shown) that may be disposed within the wellbore 202, including metal tubulars (e.g., casing), cement, solidified drilling fluid. Thus, during the bonding operations, the molten sealing material 274 may be discharged and/or injected or otherwise directed into the annular space 266 between the wellbore plug 218 and the other materials or devices that may be disposed within the wellbore 202. As described above, after being ignited, the high-temperature molten sealing material 274 melts a portion of the wellbore plug 218 and the other materials and/or devices within the wellbore 202, thereby causing the molten wellbore plug 218 and the other materials and/or devices to mix with each other and/or with the molten sealing material 274. As the molten sealing material 274 cools and solidifies, the bonding material bonds with the wellbore plug 218 and the other materials and/or devices thereby fusing or otherwise bonding the wellbore plug 218 and the other materials and/or devices. Such bonding operations result in both a molecular (or chemical) bond and a physical (or mechanical) bond between the wellbore plug 218 and the other materials and/or devices.

One or more aspects of the present disclosure may therefore be further applicable to and/or readily adaptable for utilizing in a cased-hole portion of a wellbore 202 to permanently seal the wellbore 202. Accordingly, wellbore sealing operations within the scope of the present disclosure may further comprise operations to remove a casing and the cement lining the wellbore, before or during bonding operations.

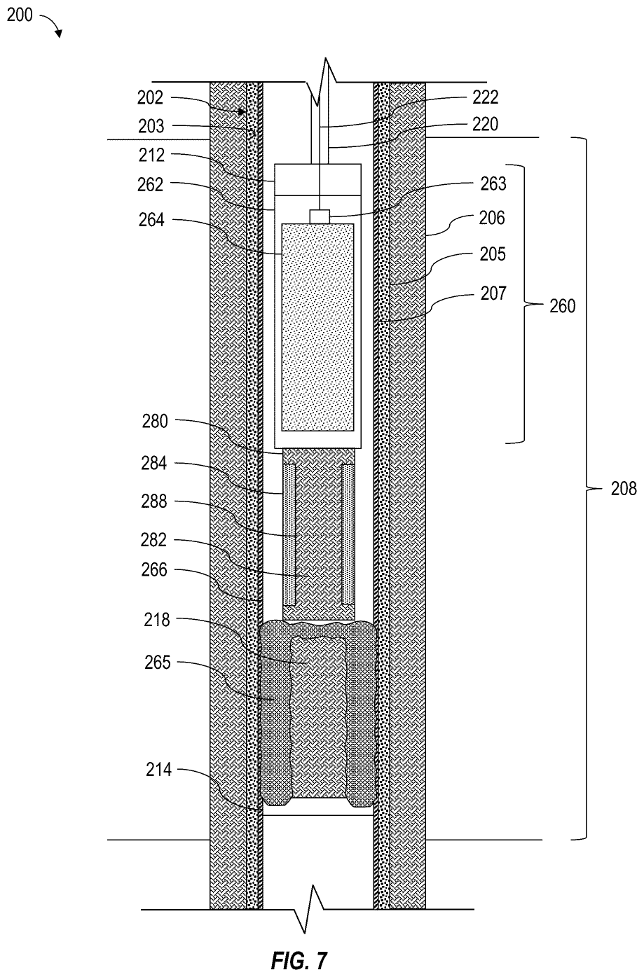

FIG. 7 is a schematic sectional view of a portion of the wellsite system 200 shown in FIGS. 1-6. However, FIG. 7 shows a casing 207 fixed within the wellbore 202 via cement 205 and a different apparatus for performing or otherwise facilitating different wellbore sealing operations to permanently seal the wellbore 202.

As shown, the wellbore sealing operations may include installing a wellbore plug 218 (or another packing member or well plug) within the wellbore 202 against the casing 207, such as by conveying the wellbore plug 218 within the wellbore 202 and positioning the wellbore plug 218 at a predetermined depth along a cap rock zone 208 of the rock formation 206, as described above. The wellbore sealing operations may further comprise bonding operations to bond the wellbore plug 218 with the casing 207 within the wellbore 202.

Thereafter, a casing eradication formation system (or apparatus) 280 may be positioned downhole on top of the installed wellbore plug 218. The casing eradication formation system 280 may comprise a modified wellbore plug 282 and a reactive material (or mixture) 284.

The reactive material 284 may be or may comprise a high energy thermite 284 configured (or formulated) to undergo an exothermic reaction that results in high energy products that can melt, break down, corrode, disintegrate, destroy, or otherwise eradicate a portion of the casing 207, the cement layer 205, and/or the rock formation 206 behind the casing 207 and cement 205 along or adjacent to the casing eradication formation system 280, thereby exposing the sidewall 203 of the rock formation 206 defining the wellbore 202. The high energy thermite 284 by be configured to undergo the exothermic reaction at a high burn rate, at a high temperature, and/or at a high mass flow rate of the resulting high energy products, such that the resulting high energy products can eradicate a portion of the casing 207, the cement layer 205, and/or the rock formation 206 behind the casing 207 and cement 205. The reactive material 284 may also or instead comprise surfactants, solvents, sealants, and/or other molecular seal catalysts that can eradicate a portion of the casing 207, the cement layer 205, and/or the rock formation 206 behind the casing 207 and cement 205. However, the reactive material 284 may instead be configured to produce (or generate), while undergoing an exothermic reaction or while interacting with the molten sealing material 274, the surfactants, solvents, sealants, and/or other molecular seal catalysts that can eradicate a portion of the casing 207, the cement layer 205, and/or the rock formation 206 behind the casing 207 and cement 205.

The modified wellbore plug 282 may be configured to carry or otherwise contain the reactive material 284 and, thus, facilitate delivery of the reactive material 284, from the wellsite surface 204 to a predetermined depth within the wellbore 202. For example, the reactive material 284 may be disposed on the surface of the modified wellbore plug 282. The modified wellbore plug 282 may also or instead comprise a void 288 (e.g., a channel, a bore, a cavity) containing the reactive material 284. The reactive material 284 may be layered on the surface of the modified wellbore plug 282 or within the void 288 of the modified wellbore plug 282, wherein each layer of the reactive material 284 may be configured to perform or cause the performance of a different operation. Layering of the reactive material 284 may therefore permit the different operations to be performed in a predetermined sequence.

After the reactive material 284 undergoes an exothermic reaction or is otherwise used up and at least a portion of the casing 207, the cement layer 205, and/or the rock formation 206 behind the casing 207 and cement 205 is eradicated, the modified wellbore plug 282 may also be used as a plug or a material filler to facilitate permanent sealing of the wellbore 202. The modified wellbore plug 282 may comprise the same or a similar composition to the wellbore plug 218 composition, as described herein.

As further shown, after the casing eradication formation system 280 is positioned on top of the installed wellbore plug 218, a downhole tool string 260 comprising a sealing material delivery apparatus 262 may be deployed within the wellbore 202 and conveyed downhole until the sealing material delivery apparatus 262 is in contact or close proximity with the casing eradication formation system 280.

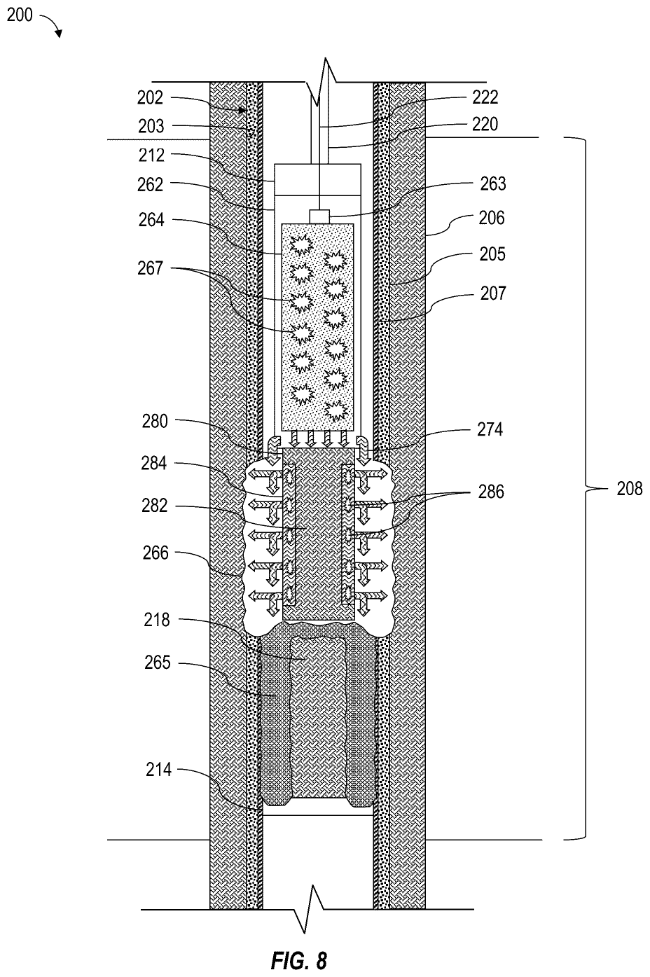

FIGS. 8-10 are schematic sectional views of a portion of the wellsite system 200 shown in FIG. 7. FIGS. 8-10 comprise an apparatus for performing wellbore sealing operations, within the scope of the present disclosure, and show the apparatus in different stages of wellbore sealing operations, including casing destruction and bonding operations.

As shown in FIG. 8, after the igniter 263 ignites the sealing material 264 to cause the sealing material 264 to undergo an exothermic reaction 267 and take on a molten (or viscous) form, the sealing material delivery apparatus 262 directs the flow of the molten sealing material 274 into the annular space 266 between the casing 207 and the casing eradication formation system 280, thereby igniting the reactive material 284 to cause the reactive material 284 to undergo an exothermic reaction 286 and take on a molten form. As the molten reactive material 284 flows through the annular space 266, the molten reactive material 284 eradicates the casing 207 and the cement 205, thereby exposing the sidewall 203 of the rock formation 206 defining the wellbore 202.

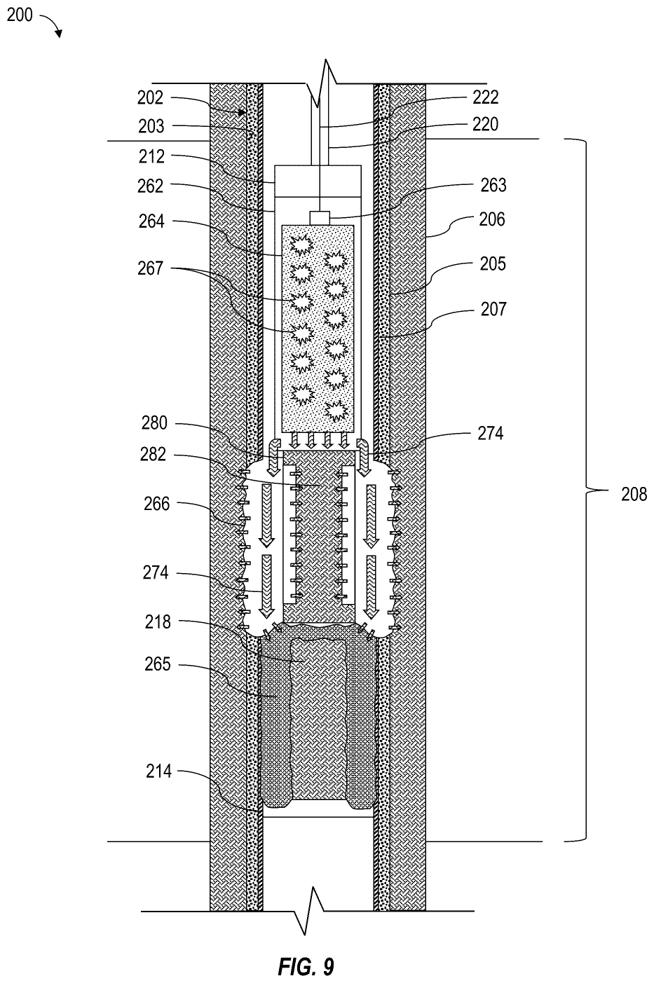

As shown in FIG. 9, while or after the molten reactive material 284 eradicates the casing 207, the cement layer 205, and/or the rock formation 206 behind the casing 207 and cement 205, the molten sealing material 274 flows into the enlarged annular space 266 between the sidewall 203 of the rock formation 206 and the modified wellbore plug 282, which was previously taken up by the casing 207 and the cement 205. As the molten sealing material 274 flows through the annular space 266, the molten sealing material 274 flows into cracks, fissures, fractures, and other interstitial voids extending into the modified wellbore plug 282 and the rock formation 206 of the wellbore 202, melting a portion of the modified wellbore plug 282 and the rock formation 206 of the wellbore 202 (and the sealing composite material 265 of the previously installed wellbore plug 218) to a certain depth below their respective surfaces, resulting in a mixing of the molten sealing material 274 and the molten modified wellbore plug 282 and rock formation 206.

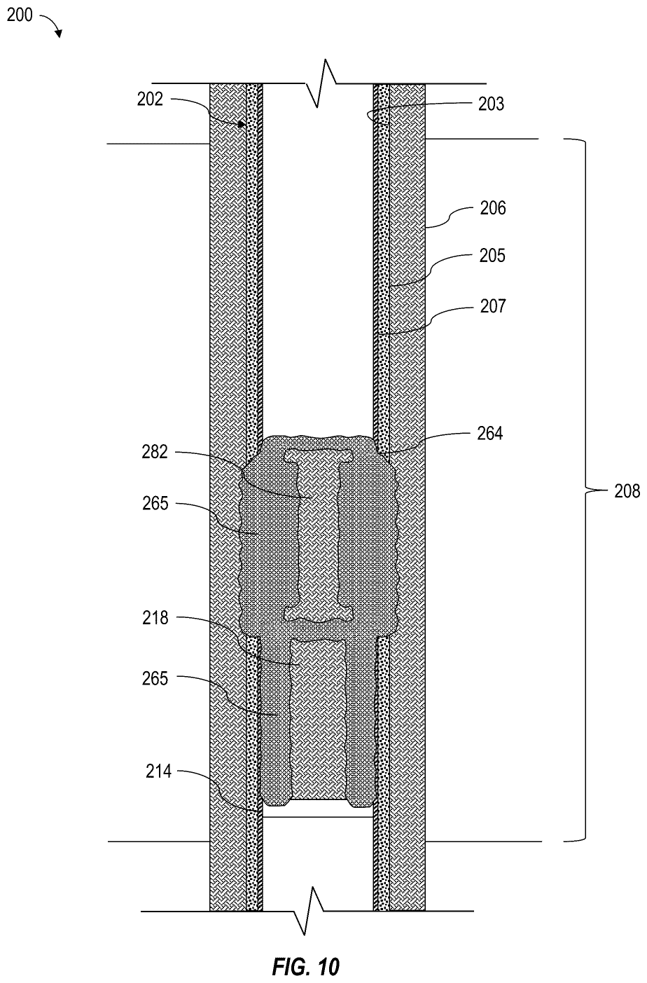

As shown in FIG. 10, upon cooling and solidification (or curing) of the molten sealing material 274, the wellbore plug 282, and the rock formation 206, the bonding material bonds with the wellbore plug 282, the rock formation 206, and the constituent chemicals of the wellbore plug 282 and the rock formation 206, thereby forming a sealing composite material 265, fusing or otherwise bonding together the modified wellbore plug 282 and the rock formation 206 of the wellbore 202 to permanently seal the wellbore 202.

The casing destruction and bonding operations described above and shown in FIGS. 7-10 may be repeated to position additional casing eradication formation systems 280 and sealing material delivery apparatuses 262 within the wellbore 202 to eradicate additional portions (or lengths) of the casing 207, the cement layer 205, and/or the rock formation 206 behind the casing 207 and cement 205, and to bond the additional modified wellbore plugs 282 to the rock formation 206, to permanently seal the wellbore 202 along the entire cap rock zone 208.

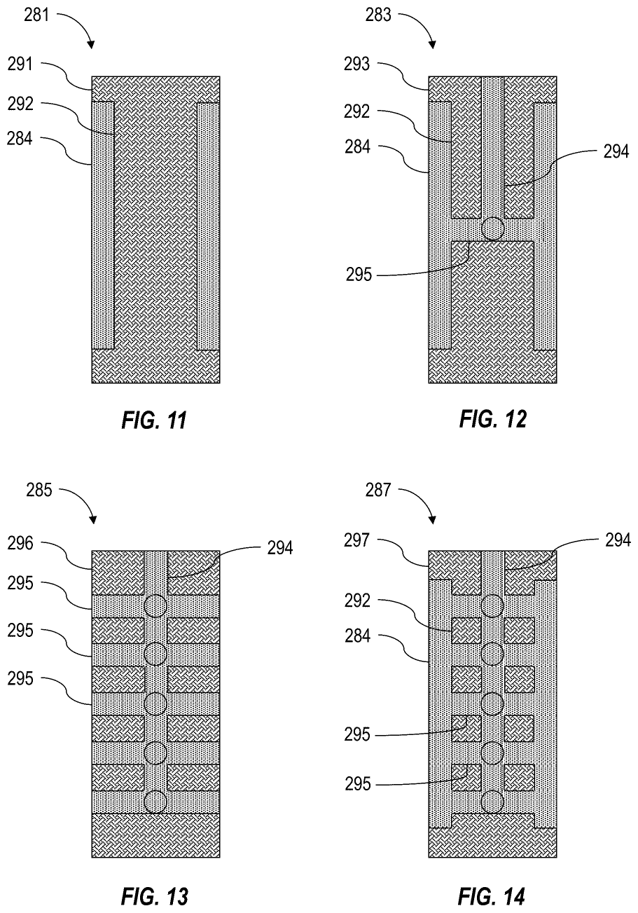

FIGS. 11-14 show schematic sectional views of casing eradication wellbore plugs 281, 283, 285, 287. Each casing eradication wellbore plug 281, 283, 285, 287 may be an exemplary embodiment of the casing eradication formation system 280 shown in FIGS. 7-10, and may comprise one or more features and modes of operation of the casing eradication formation system 280. Each casing eradication wellbore plug 281, 283, 285, 287 may be deployed within the wellbore 202 and conveyed downhole to a predetermined depth along the wellbore 202. Each casing eradication wellbore plug 281, 283, 285, 287 may contain a reactive material 284, which may be ignited to eradicate the casing 207, the cement layer 205, and/or the rock formation 206 behind the casing 207 and cement 205, thereby exposing the sidewall 203 of the rock formation 206 defining the wellbore 202.

FIG. 11 shows a schematic sectional view of a casing eradication wellbore plug 281 comprising a modified wellbore plug 291 having a channel (or groove) 292 extending circumferentially along an outer surface of the modified wellbore plug 291. The channel 292 may contain a predetermined amount of a reactive material 284.

FIG. 12 shows a schematic sectional view of a casing eradication wellbore plug 283 comprising a modified wellbore plug 293 having a channel (or groove) 292 extending circumferentially along an outer surface of the modified wellbore plug 291. The modified wellbore plug 293 may further include a channel (or bore) 294 extending axially therethrough, and a plurality of channels (or bores) 295 extending radially therethrough between the channels 292, 294. The channels 292, 294, 295 may contain a predetermined amount of a reactive material 284.

FIG. 13 shows a schematic sectional view of a casing eradication wellbore plug 285 comprising a modified wellbore plug 296 having a channel (or bore) 294 extending axially (or vertically) therethrough, and a plurality of channels (or bores) 295 extending radially (or laterally) between the channel 294 and the outer surface of the modified wellbore plug 296. The channels 295 may extend through the modified wellbore plug 296 at different axial positions thereof. The channels 294, 295 may contain a predetermined amount of a reactive material 284.

FIG. 14 shows a schematic sectional view of a casing eradication wellbore plug 287 comprising a modified wellbore plug 297 having a channel (or groove) 292 extending circumferentially along an outer surface of the modified wellbore plug 291. The modified wellbore plug 297 may further include a channel (or bore) 294 extending axially therethrough and a plurality of channels (or bores) 295 extending radially therethrough between the channels 292, 294. The channels 295 may extend through the modified wellbore plug 297 at different axial positions thereof. The channels 292, 294, 295 may contain a predetermined amount of a reactive material 284.

Embodiments of the present invention may further include rapid testing and validation of the sealing material 264 for compliance based on chemical constituency or further based on actual validation testing (e.g., pressure testing, injection concentration testing, decay products testing).

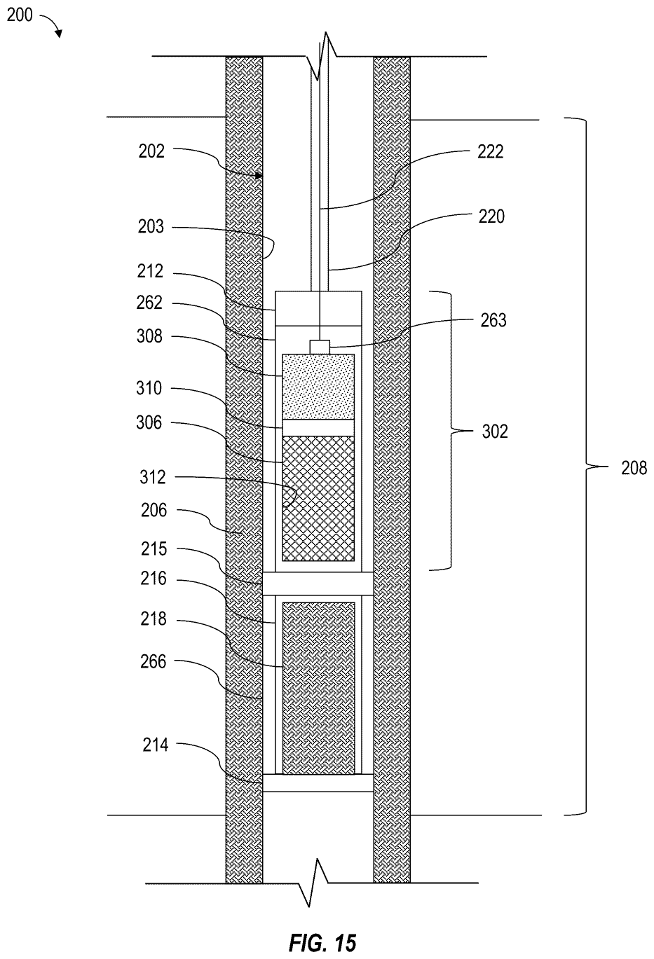

FIGS. 15-17 are schematic sectional views of a portion of the wellsite system 200 shown in FIGS. 1-10. FIGS. 15-17 comprise an apparatus for performing wellbore sealing operations within the scope of the present disclosure and show the apparatus in different stages of wellbore sealing operations.

As shown in FIG. 15, the wellbore sealing operations may include conveying a wellbore plug 218 (or another packing member or well plug) within a wellbore 202 via a wellbore plug delivery apparatus 216 and positioning the wellbore plug 218 at a predetermined depth along a cap rock zone 209 of the rock formation 206. The wellbore sealing operations may further comprise performing bonding operations to bond the wellbore plug 218 to the rock formation 206 of the wellbore 202 to permanently seal the wellbore 202.

The wellbore plug delivery apparatus 216 and the wellbore plug 218 may be deployed and conveyed within the wellbore 202 from the wellsite surface 204 via the conveyance line 220. After the wellbore plug 218 is conveyed within the wellbore 202 to the predetermined depth, the wellbore plug 218 may be held or otherwise maintained in the predetermined depth by the holding apparatus 214. Thereafter, a tool string 302, comprising a bonding material delivery apparatus 262, may be deployed within the wellbore 202. The bonding material delivery apparatus 262 may define an internal chamber 312 having a lower portion containing a bonding (or sealing) material 306 for bonding together the wellbore plug 218 and the rock formation 206 of the wellbore 202 to seal the wellbore 202. The tool string 302 may be conveyed via the conveyance line 220 to the wellbore plug 218 until the bonding material delivery apparatus 262 contacts or is in close proximity to the wellbore plug 218, thereby delivering the bonding material 306 to the wellbore plug 218.

An upper portion of the internal chamber 312 of the bonding material delivery apparatus 262 may contain a gas producing material (or gas producing thermite) 308 formulated to undergo an exothermic reaction to generate a high-pressure gas. The bonding material delivery apparatus 262 may further comprise a separator (e.g., a piston) 310 movably (e.g., slidably) disposed within the internal chamber 312 between the bonding material 306 and the gas producing material 308, thereby fluidly separating the bonding material 306 and the gas producing material 308. The bonding material delivery apparatus 262 may further comprise an igniter 263 operable to ignite the gas producing material 308 to initiate an exothermic reaction of the gas producing material 308 thereby causing the gas producing material 308 to generate the high-pressure gas.

The bonding material 306 may comprise a movement sensitive material configured to change between solid and liquid states, based on whether or not the bonding material 306 is dynamic (flowing) or static (not flowing). For example, the bonding material 306 can take on or maintain a solid state when static, and can take on or maintain a liquid (or viscous) state when flowing. Such bonding material 306 may be sensitive to ambient (or surrounding) pressure to change between the solid and liquid states. For example, the bonding material 306 may take on or maintain a solid state under relatively low pressures, and the bonding material 306 may take on or maintain a liquid state under relatively high pressures. Thus, during downhole conveyance of the bonding material delivery apparatus 262, the bonding material 306 may be static and, thus, in a solid state. An exemplary embodiment of the bonding material 306 may comprise a sodium metasilicate (Na₂SiO₃).

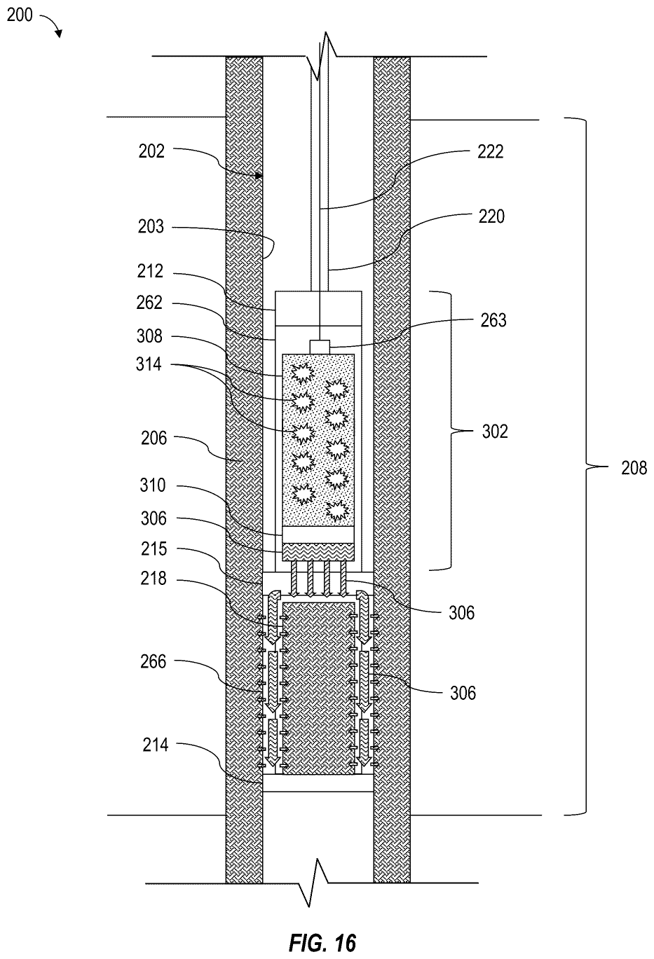

As shown in FIG. 16, after the bonding material delivery apparatus 262 is conveyed within the wellbore 202 and positioned in contact with or in close proximity of the wellbore plug delivery apparatus 216 and the wellbore plug 218 contained therein, an ignitor 263 may be operated from the wellsite surface 204, via the power and control center 250, to ignite the gas producing material 308 to thereby cause an exothermic reaction 314 of the gas producing material 308 to thereby initiate bonding operations to bond together the wellbore plug 218 and the rock formation 206 of the wellbore 202. During the bonding operations, the exothermic reaction 314 of the gas producing material 308 may generate high-pressure gas to increase pressure within the upper portion of the internal chamber 312 containing the gas producing material 308. The increased pressure applies a force to the separator 310 which, in turn, compresses the bonding material 306. The increased pressure (and force) imparted to the bonding material 306 may cause the solid bonding material 306 to take on a liquid state, be discharged from the bonding material delivery apparatus 262, and directed into the annular space (or gap) 266 between the outer surface of the wellbore plug 218 and the inner surface (i.e., the sidewall 203) of the rock formation 206 of the wellbore 202. As the liquid bonding material 306 flows through the annular space 266, the bonding material 306 flows into cracks, fissures, fractures, and other interstitial voids extending into the wellbore plug 218 and the rock formation 206 of the wellbore 202. The holding apparatus 214 may prevent or inhibit the liquid bonding material 306 from flowing out of the annular space 266 into the wellbore 202 below the wellbore plug 218.

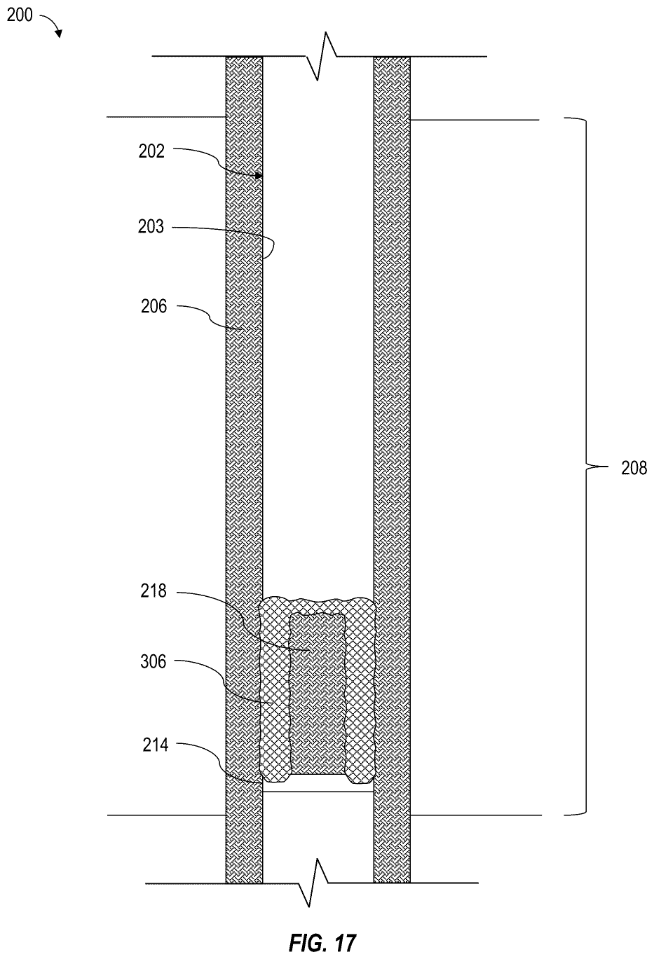

As shown in FIG. 17, when the liquid bonding material 306 becomes static (i.e., stops flowing) within the annular space 266, the liquid bonding material 306 may take on a solid form (or solidify) within the annular space 266 and the interstitial voids extending into the wellbore plug 218 and the rock formation 206 of the wellbore 202, thereby bonding together the wellbore plug 218 and the rock formation 206 of the wellbore 202 to permanently seal the wellbore 202. While in its solid form, the bonding material 306 has a high resistance to chemical attacks and degradation.

The wellbore sealing operations described above and shown in FIGS. 15-17 may be repeated to position additional wellbore plugs 218 and bonding material delivery apparatuses 262 within the wellbore 202 to bond the additional wellbore plugs 218 to the rock formation 206 with additional bonding material 306 to permanently seal the wellbore 202 along the entire cap rock zone 208.

Although FIGS. 1-17 and the corresponding description describe wellbore sealing operations that utilize one or more wellbore plugs 218 to permanently seal the wellbore 202, it is to be understood that the downhole tool strings 260, 302 described herein can be used to permanently seal the wellbore 202 without the use of wellbore plugs 218.

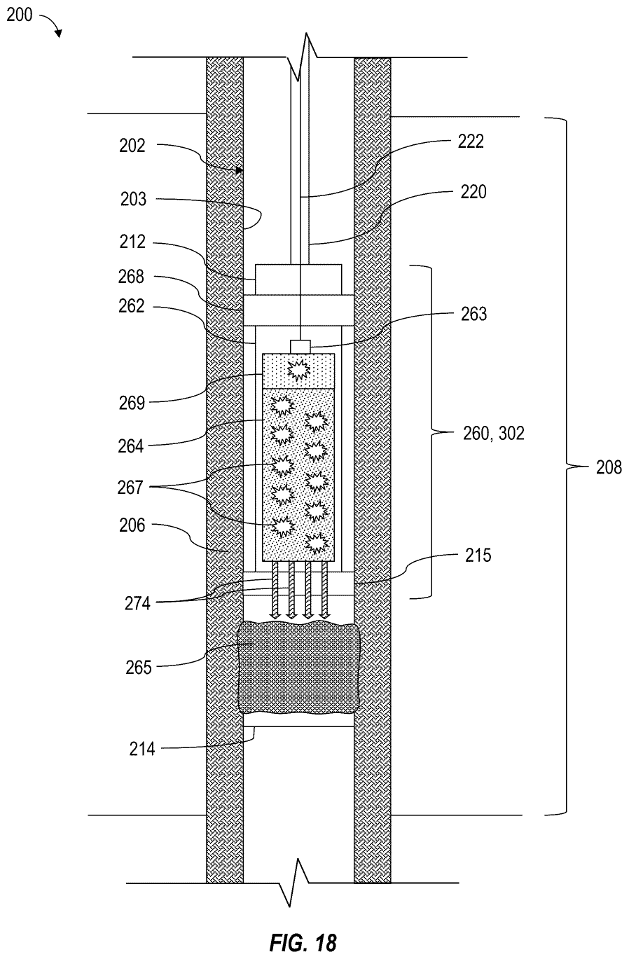

FIG. 18 is a schematic sectional view of a portion of the wellsite system 200 shown in FIGS. 1-10 and 15-17 during wellbore sealing operations that do not use a wellbore plug 218 to permanently seal the wellbore 202. As shown, the wellbore sealing operations may include conveying within the wellbore 202 via a conveyance line 220 a downhole tool string 260 comprising a sealing material delivery apparatus 262 to a predetermined depth at which the wellbore 202 is intended to be permanently sealed, such as along the cap rock zone 202. The sealing material delivery apparatus 262 may contain a sealing material 264 for permanently sealing the wellbore 202. The downhole tool string 260, the sealing material delivery apparatus 262, and the scaling material 264 may comprise one or more features and modes of operation as described above, including when indicated by the same reference numbers.

The tool sting 260 or the sealing material delivery apparatus 262 may comprise an engagement apparatus 215 configured to engage the sidewall 202 of the wellbore 202 and maintain the sealing material delivery apparatus 262 at the predetermined depth. Thus, after the sealing material delivery apparatus 262 is conveyed within the wellbore 202 to the predetermined depth, the engagement apparatus 215 may be operated from the wellsite surface 204 via the power and control system 250 or by pulling on the conveyance line 220 from the wellsite surface 204 to cause the engagement apparatus 215 to engage the sidewall 203 of the wellbore 202 to prevent or inhibit movement of the engagement apparatus 215, and thus the sealing material delivery apparatus 262, along the wellbore 202.

The engagement apparatus 215 may be operated at a predetermined distance above a holding apparatus 214 installed within the wellbore 202 to maintain the sealing material delivery apparatus 262 at the predetermined distance above the holding apparatus 214. The holding apparatus 214 may be conveyed within the wellbore 202 via a conveyance line 220 to the predetermined depth before the sealing material delivery apparatus 262 is conveyed within the wellbore 202. The holding apparatus 214 may then be operated from the wellsite surface 204 (e.g., by applying tension to the conveyance line 220 or by way of a control signal from the power and control system 250 via the conductor 222) to engage the sidewall 203 of the wellbore 202 to therefore prevent or inhibit movement of the holding apparatus 214 along the wellbore 202. Instead of being conveyed within the wellbore 202 separately, the holding apparatus 214 may be connected to or otherwise carried by the sealing material delivery apparatus 262 at the predetermined distance below the sealing material delivery apparatus 262. The holding apparatus 214 and the engagement apparatus 215 may then be operated at the same time or at different times to engage the sidewall 203 of the wellbore 202.

As further shown in FIG. 18, after the tool string 260 (including the sealing material delivery apparatus 262) is conveyed within the wellbore 202 and positioned at the predetermined depth and at the predetermined distance from the holding apparatus 214, an ignitor 263 may be operated from the wellsite surface 204, via the power and control center 250, to ignite the sealing material 264 (and/or the gas producing material 308, if included) to thereby cause an exothermic reaction 267 of the sealing material 264 to thereby causing the sealing material 264 to produce the bonding material and to take on a molten state.

During the wellbore bonding operations, after the igniter 263 ignites the sealing material 264, the sealing material delivery apparatus 262 discharges and directs the flow of the molten sealing material 274 (including the bonding material) into the wellbore 202 below the sealing material delivery apparatus 262, onto the holding apparatus 214, and into contact with the rock formation 206 making up the sidewall 203 of the wellbore 202. As the high-temperature molten sealing material 274 contacts the sidewall 203 of the wellbore 202, the molten sealing material 274 flows into cracks, fissures, fractures, and/or other interstitial voids extending into the rock formation 206 along the sidewall 203. The high-temperature molten sealing material 274 melts a portion of the rock formation 206 of the wellbore 202 to a certain depth below their respective surfaces, resulting in a mixing of the molten sealing material 274 with the chemical constituents of the molten rock formation 206. The holding apparatus 214 prevents or inhibits the molten sealing material 274 from flowing out of the annular space 266 into the wellbore 202 below the holding apparatus 214.

After the molten sealing material 274 is fully discharged from the sealing material delivery apparatus 262 into the wellbore 202 above the holding apparatus 214, the sealing material delivery apparatus 262 may be retrieved to the wellsite surface 204 via the conveyance line 220. After the molten sealing material 274 is fully discharged from the sealing material delivery apparatus 262, the molten sealing material 274 (including the molten bonding material) and rock formation 206 cool and solidify while the bonding material forms a physical and/or molecular bond with the constituent chemicals of the rock formation 206 and constituent particles included in the sealing material 264. The solidified (or cured) sealing composite material 265 comprising the bonding material and the constituent particles form a permanent seal along the wellbore 202.

It is to be further understood that the downhole tool string 302 shown in FIGS. 15 and 16 may be used to permanently seal the wellbore 202 without the use of wellbore plugs 218. For example, the downhole tool string 302 may be operated in the same or similar manner as the tool string 260 described above and shown in FIG. 18.

Although FIGS. 3, 4, 6-9, 15, 16, and 18 shown the sealing material delivery apparatus 262 conveyed within the wellbore 202 with outlet port(s) on the bottom (i.e., downhole) side thereof such that the sealing material 274, 306 flows into the wellbore 202 below the sealing material delivery apparatus 262, it is to be understood that the scaling material delivery apparatus 262 may be conveyed within the wellbore 202 upside-down or otherwise with outlet port(s) on the top (i.e., uphole) side thereof such that the sealing material 274, 306 flows into the wellbore 202 above or adjacent to the sealing material delivery apparatus 262. In such embodiments of the systems and operations for sealing a wellbore 202, after the sealing material 274, 306 is discharged from the sealing material delivery apparatus 262, the sealing material delivery apparatus 262 may solidify (or cure), thereby forming a sealing composite material 265 plug, which seals the wellbore 202. During such sealing operations, the sealing material 274 may melt or otherwise disintegrate the sealing material delivery apparatus 262, thereby forming the sealing composite material 265 plug at the location of the scaling material delivery apparatus 262. During the sealing operations, the scaling material 306 may instead flow within and around the sealing material delivery apparatus 262, such that the sealing composite material 265 plug incorporates the sealing material delivery apparatus 262 as part thereof. During the sealing operations, the sealing material 274, 306 may instead be discharged above the sealing material delivery apparatus 262 and form the sealing composite material 265 plug above the sealing material delivery apparatus 262. The sealing material 306 may be maintained above the sealing material delivery apparatus 262 by an engagement apparatus 215 or an outer seal 268 located along or on top of the sealing material delivery apparatus 262 or otherwise below the outlet ports of the sealing material delivery apparatus 262. Because the sealing composite material 265 plug is formed along or above the sealing material delivery apparatus 262, the sealing material delivery apparatus 262 may be left within the wellbore 202 during the wellbore sealing operations after the sealing material 274, 306 is discharged therefrom.

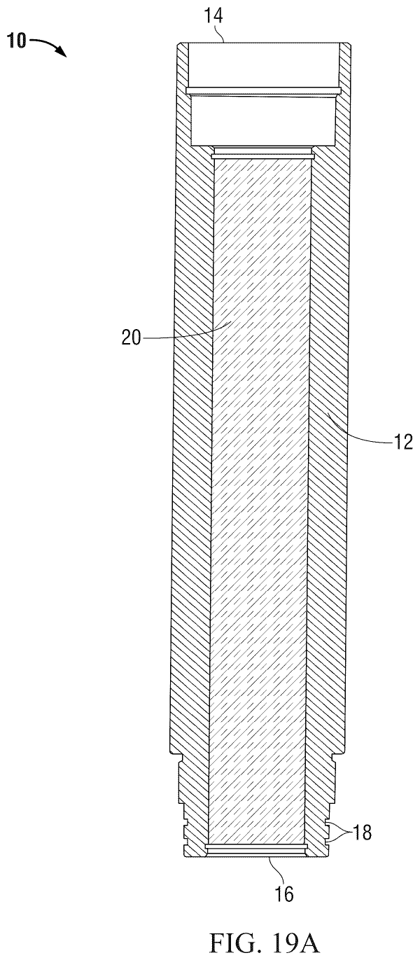

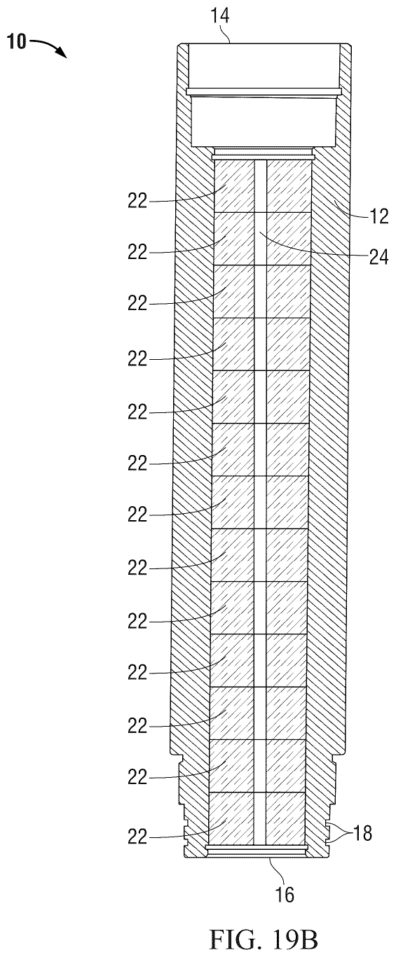

Referring now to FIG. 19A, a cross-sectional view of an example embodiment of a sealing material delivery apparatus 10 is shown. The sealing material delivery apparatus 10 is an exemplary embodiment of the sealing material delivery apparatus 262, which is shown in FIGS. 3, 4, 6-9, 15, 16, and 18 described above.

The sealing material delivery apparatus 10 is configured for containing a scaling material 20 and isolating the sealing material 20 as the sealing material delivery apparatus 10 is conveyed within a wellbore to deliver the sealing material 20 to a wellbore plug positioned within the wellbore. The sealing material delivery apparatus 10 may be further operable to discharge and/or inject or otherwise direct the sealing material 20 into an annular space between the wellbore plug and the rock formation of the wellbore to bond the wellbore plug 218 and the rock formation 206 to permanently seal the wellbore 202, as described above. The sealing material delivery apparatus 10 may be adapted for discharging a molten sealing material 20 in an axial (e.g., downhole) direction within the wellbore.

It should be understood that while FIG. 19A depicts a generally tubular, torch-like apparatus 10 as an exemplary embodiment, configured to project a sealing material in a manner to inject or otherwise direct the sealing material into an annular space between the wellbore plug and the rock formation of the wellbore, the apparatus 10 can be used without departing from the scope of the present disclosure. Additionally, as described below, while the depicted embodiment can be used as an apparatus for projecting a sealing material in an axial direction within the wellbore, the depicted embodiment could alternatively be attached (e.g., threaded) to one or more other apparatus usable to project the sealing material in the axial direction, such that the depicted apparatus 10 is usable as an associated container for retaining the sealing material therein.

Specifically, the depicted apparatus 10 is shown having an elongate, tubular body 12 having a box end 14 and a pin end 16. The pin end 16 is depicted having sealing elements 18 (e.g., O-rings or similar elastomeric and/or sealing members) associated therewith. A sealing material 20 is shown disposed within the apparatus 10, and substantially fills the central bore of the body 12. In an embodiment, the sealing material 20 can include thermite and/or a thermite mixture, as described above. FIG. 19A depicts the body 12 containing sealing material (e.g., a single piece of sealing material (an elongated pellet) or a densely packed concentration of pellets), and it should be understood that the sealing material 20 can include any form and/or quantity of material. For example, FIG. 19B depicts an embodiment of an apparatus 10, in which the sealing material includes multiple, discrete pellets 22, each having a central passage therethrough (e.g., for increasing surface area), to define a continuous central passage 24. One or more of the discrete pellets 22 located at the box end 14 (an upper end) of the central passage 24 may comprise a thermite and/or a mixture of thermite and one or more polymers adapted to produce a gas as the thermite combusts to force (or push) molten sealing material 20 into an annular gap between a wellbore plug and a rock formation of a wellbore.

In operation, the box end 14 and/or the pin end 16 of the apparatus 10 can be configured to function as a nozzle, such that when the sealing material 20 is ignited (e.g., through actuation of a thermal generator or other type of ignition source or actuator), the sealing material is projected through the nozzle, generally parallel to the axis of the body 12. The sealing material can subsequently flow over the wellbore plug and into the annular space.

As described above, however, the depicted apparatus 10 can be used in conjunction with additional containers and/or apparatus containing additional sealing material, or the depicted apparatus 10 can function as a carrier for a sealing material 20 for use by an associated apparatus. Similarly, an initiation apparatus can be threaded to and/or otherwise engaged with either end 14, 16 of the apparatus 10. Further, other attachments and/or components can be engaged with the depicted apparatus 10, such as a stand-off member, an anchor and/or attachment/latching mechanism, or other similar components, as described above.

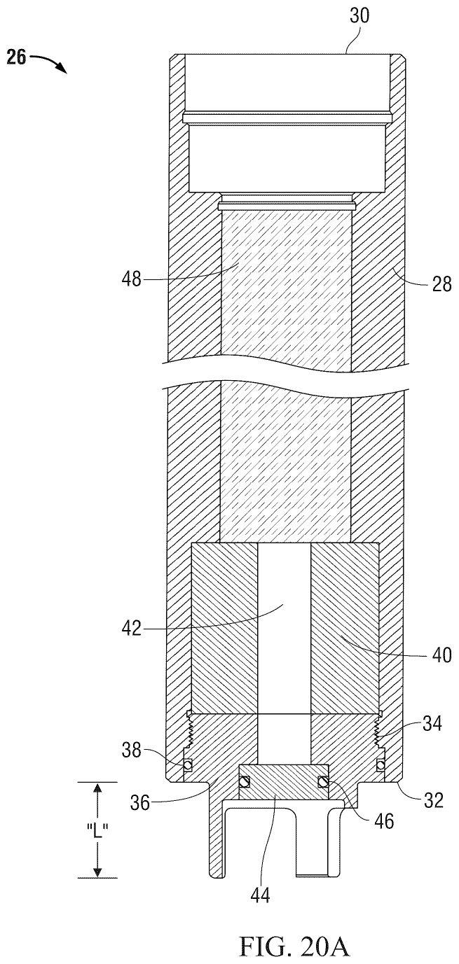

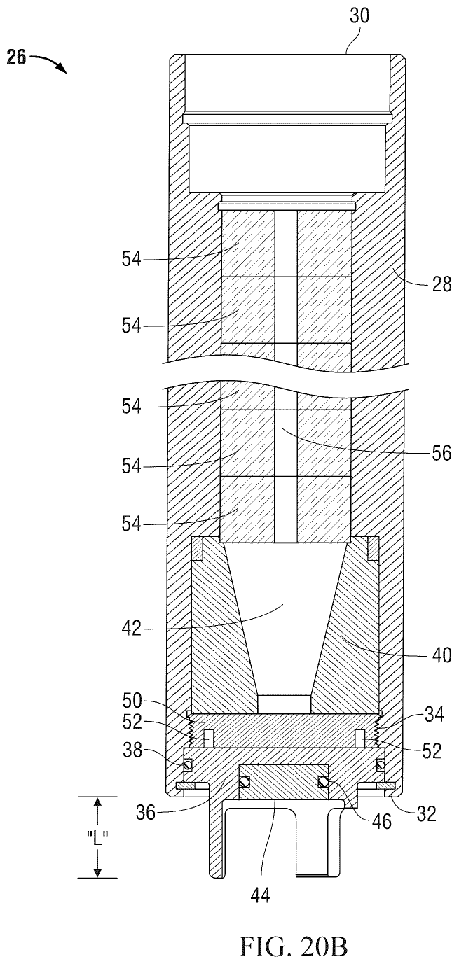

Referring now to FIG. 20A, a cross-sectional view of an embodiment of a sealing material delivery apparatus 26 is shown. The sealing material delivery apparatus 26 is an exemplary embodiment of the sealing material delivery apparatus 262 shown in FIGS. 3, 4, 6-9, 15, 16, and 18 and described above. Accordingly, the sealing material delivery apparatus 26 may comprise one or more features and/or modes of operation of the sealing material delivery apparatus 262.

The sealing material delivery apparatus 26 is configured for containing a sealing material and isolating the sealing material as the sealing material delivery apparatus 26 is conveyed within a wellbore to deliver the sealing material 48 to a wellbore plug positioned within the wellbore. The sealing material delivery apparatus 26 may be further operable to discharge and inject or otherwise direct the sealing material 48 into an annular space between the wellbore plug 218 and the rock formation 206 of the wellbore 202 to bond the wellbore plug 218 and the rock formation 206 to permanently seal the wellbore 202, as described above.

The apparatus 26 is depicted having a generally tubular body 28 with a first end 30 having threads and/or a box connection, and a second end 32. The second end 32 is depicted having interior threads 34, usable for engagement with a stand-off member 36. The stand-off member 36 is shown engaged with the body 28 via the threads 34, and a sealing member 38 (e.g., an O-ring or similar element) is shown secured between the stand-off member 36 and the interior surface of the body 28. As described above, the stand-off member 36 can be usable to provide a space between the second end 32 of the body 28 and a wellbore plug within the wellbore, such as through contact between the wellbore plug and one or more protruding portions of the stand-off member 36. Specifically, FIG. 20A shows the stand-off member 36 having a plurality of protruding elements extending beyond the second end 32 of the body 28, at a selected length (L), which provides an effective space between the body 28 and a wellbore plug in the wellbore, such that the projection of a sealing material from the apparatus 26 toward the wellbore plug will be less likely to damage and/or otherwise affect the body 28 of the apparatus 26.

The depicted embodiment of the apparatus 26 is shown having an insert 40 disposed within the body 28 proximate to the second end 32, which in an embodiment, can be formed from graphite or a similar material that will remain generally unaffected by the consumption of a sealing material and the projection of a sealing material. The insert 40 is shown having an internal bore, which is continuous with a bore through the stand-off member 36, defining a nozzle 42 at the second end 32 of the body 28. The stand-off member 26 is depicted having a seal and/or plug 44 engaged therewith, over the nozzle 42, with an associated O-ring or similar sealing member 46, such that the seal and/or plug 44 blocks the opening of the nozzle 42 while the apparatus 26 is lowered and/or otherwise positioned within the wellbore. The seal and/or plug 44 thereby prevent(s) the entry of contaminants into the nozzle 42 and body 28, until the apparatus 26 is actuated. As described herein, consumption of the sealing material 48 can include thermite and/or a thermite mixture, causing projection of the burning or otherwise molten sealing material through the nozzle 42, which can remove and/or penetrate and/or otherwise degrade the seal and/or plug 44, and then contact the wellbore plug causing the sealing material to flow into the annular space between the wellbore plug and the rock formation of the wellbore to bond the wellbore plug and the rock formation for permanently sealing the wellbore, as described above.

It should be understood that the nozzle 42, the sealing material 48, the stand-off member 36, and other components of the apparatus 26 can be readily varied and/or provided having other dimensions, shapes, and/or forms without departing from the scope of the present disclosure. For example, FIG. 20B depicts an alternate embodiment of an apparatus 26, in which the stand-off member 36 can be adjustably secured to the body 28 by way of tightening pins and/or screws 52, which can secure the stand-off member 36 to a plug and/or retainer 50. Additionally, FIG. 20B depicts the insert 40 having a generally conical interior profile, which defines the shape of the nozzle 42, which controls flow characteristics of the sealing material projected therethrough. FIG. 20B also shows the sealing material in the form of multiple discrete pellets 54 defining a continuous interior channel 56 therethrough, rather than a solid, compressed, and/or single-piece, sealing material as shown in FIG. 20A.

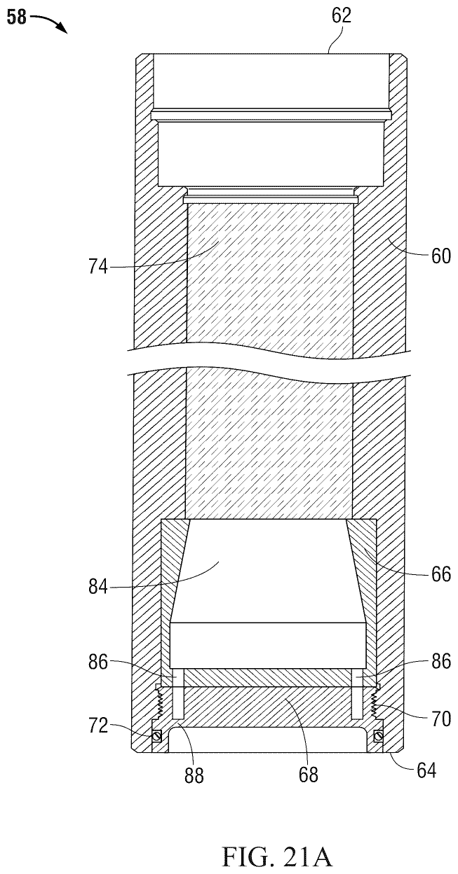

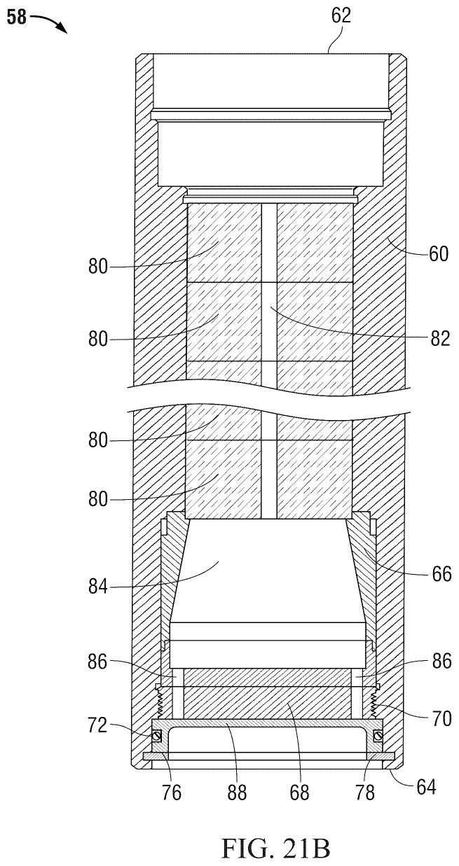

Referring now to FIG. 21A, showing a cross-sectional view of an embodiment of a sealing material delivery apparatus 58. The sealing material delivery apparatus 58 is an exemplary embodiment of the sealing material delivery apparatus 262 shown in FIGS. 3, 4, 6-9, 15, 16, and 18 and described above. Accordingly, the sealing material delivery apparatus 58 comprises the same or similar features and/or modes of operation of the sealing material delivery apparatus 262.

The sealing material delivery apparatus 58 is configured for containing a sealing material 74 and isolating the sealing material 74 as the sealing material delivery apparatus 58 is conveyed within a wellbore to deliver the sealing material 74 to a wellbore plug positioned within the wellbore. The sealing material delivery apparatus 58 is further operable to discharge and/or inject or otherwise direct the sealing material 74 into an annular space between the wellbore plug and the rock formation of the wellbore to bond the wellbore plug and the rock formation to permanently seal the wellbore, as described above.

The apparatus 58 is depicted having a generally tubular body 60 with a first end 62 having threads and/or another type of box connector associated therewith, and a second end 64. The body 60 is shown having an insert 66 positioned within the interior of the body 60 and proximate to the second end 64, which, in an embodiment, the insert 66 can be formed from graphite or a similar material that will remain generally unaffected by the burning or otherwise molten sealing material 74 and the projection of and/or contact with the sealing material 74. The depicted insert 66 is shown having a generally frustoconical interior shape, with a lower portion having one or more openings therein, which defines a nozzle 84 that includes a generally broad, upper section that narrows to one or more of channels 86, which pass through the lower portion of the insert 66. A plug and/or seal 68 (e.g., a cap) is shown engaged with the second end 64 of the body, between the nozzle 84 and the exterior of the apparatus 58, via interior threads 70 within the body 60. An O-ring or similar sealing element 72 can be positioned between the plug and/or seal 68 and the body 60 for protecting the sealing material against wellbore fluid and other contaminants. The plug and/or seal 68 is shown having grooves, indentations, and/or channels that are continuous with the channels 86 within the insert 66, such that when the sealing material 74 is burning or otherwise in a molten state, the sealing material 74 can enter the nozzle 84, pass into the channels 86, and then penetrate, perforate, and/or otherwise erode at least a portion 88 of the plug and/or seal 68, between the nozzle 84 and the exterior of the apparatus 58.

It should be understood that various components of the depicted apparatus 58 can be readily modified without departing from the scope of the present disclosure. For example, FIG. 21B depicts an apparatus 58, in which the sealing material includes multiple discrete pellets 80 defining a contiguous central passageway 82 extending therethrough. The insert 66 is shown including a lower portion, with an angled and/or convex surface, to facilitate guiding of the molten sealing material from the broad region of the nozzle 84 into the channels 86. Additionally, the plug and/or seal 68 is shown as a two-part component in which an upper portion thereof 68 (e.g., an insert) is abutted by a plug and/or sealing member 76 of a lower portion 88, while the plug and/or sealing member 76 can be retained in place via a snap ring 78 or similar retaining member.

Each of the embodiments shown in FIGS. 19A through 21B are exemplary embodiments of a sealing material delivery apparatus usable to project a sealing material in a direction generally parallel to the axis of a wellbore (e.g., in an uphole and/or downhole direction); and as such, it should be understood that any type of thermite based apparatus configured to project a burning or otherwise molten sealing material in an axial direction can be used without departing from the scope of the present disclosure.

In use, any of the above-described embodiments, and/or another similar apparatus configured to project a sealing material in an axial direction can be positioned within a wellbore (e.g., by lowering the apparatus via a conduit engaged with the upper end/top connector thereof). The apparatus can be anchored in place in contact with or in close proximity above a wellbore plug, such as through use of a positioning and latching system, such as that described in U.S. Pat. No. 8,616,293, which is incorporated herein by reference in its entirety. For example, a latching member can be engaged to an embodiment of the present apparatus via a connection to the upper end/top connector thereof. In other embodiments, various other types of anchors, setting tools, and/or securing devices can be used to retain the apparatus in a generally fixed position within a wellbore without departing from the scope of the present disclosure.

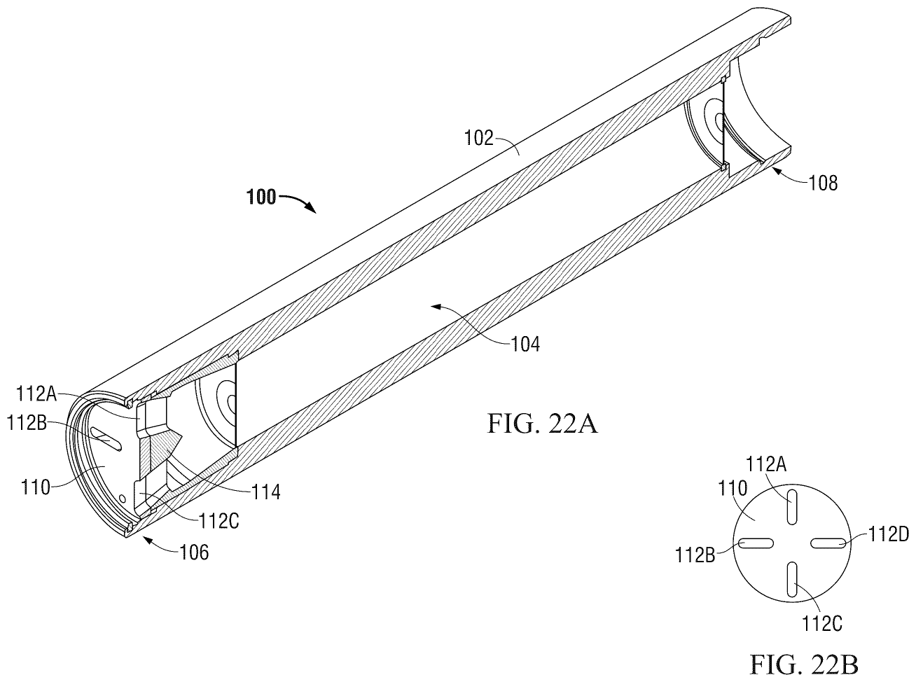

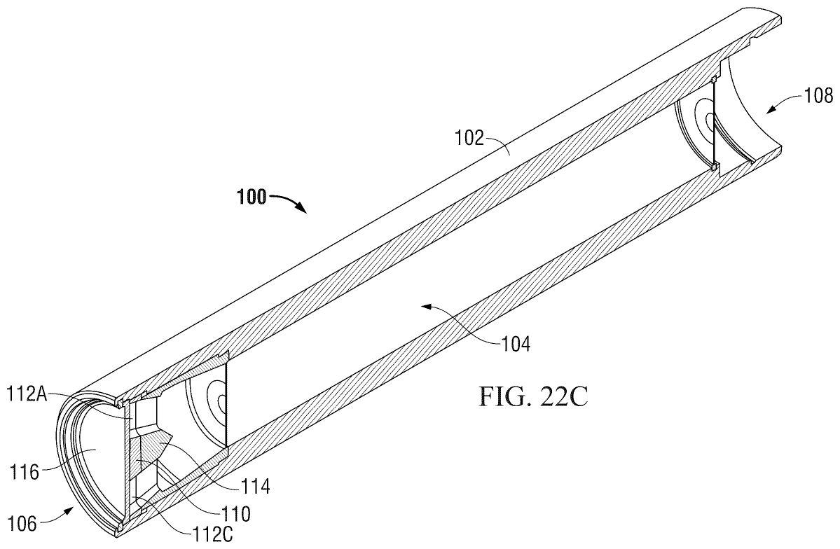

Referring now to FIG. 22A, an isometric, partial cross-sectional view of a sealing material delivery apparatus 100 is shown. The sealing material delivery apparatus 100 is an exemplary embodiment of the sealing material delivery apparatus 262 shown in FIGS. 3, 4, 6-9, 15, 16, and 18 and described above. Accordingly, the sealing material delivery apparatus 100 may comprise one or more features and/or modes of operation of the sealing material delivery apparatus 262.

The sealing material delivery apparatus 100 is configured for containing a sealing material (not shown) and isolating the sealing material as the sealing material delivery apparatus 100 is conveyed within a wellbore to deliver the sealing material to the wellbore plug positioned within the wellbore. The sealing material delivery apparatus 100 may be further operable to discharge and inject or otherwise direct the sealing material into an annular space between the wellbore plug and the rock formation of the wellbore to bond the wellbore plug and the rock formation for permanently sealing the wellbore, as described above. FIG. 22B depicts a diagrammatic end view of the apparatus 100, while FIG. 22C depicts an isometric, partial cross-sectional view of the apparatus 100 engaged with a cap 116.

The apparatus 100 is shown having a generally tubular body 102 with a bore and/or cavity 104 therein, usable to contain the sealing material. The body 102 includes a first end 106 having a nozzle 110 engaged therewith, and a second end 108 usable to engage the apparatus 100 to an adjacent component, connector, conduit, and/or other type of object.

The nozzle 110 is shown having a geometry adapted to separate a flapper valve or similar downhole object and/or obstruction into portions (e.g., wedge-shaped pieces). Specifically, the depicted nozzle 110 includes four slots 112A, 112B, 112C, 112D extending in a radial direction and spaced generally equally about the face of the nozzle 110. A diverter 114 is positioned adjacent to the nozzle 110, toward the interior of the body 102.

FIG. 22C depicts a cap 116 engaged with the first end 106 of the body 102, e.g., for preventing the ingress of material and/or fluid into the nozzle 110, and/or into the cavity 104. In an embodiment, the cap 116 can be formed from a material that can be at least partially degraded by projection of the sealing material through the nozzle 110. For example, molten sealing material projected through the slots 112A, 112B, 112C, 112D may melt, cut, and/or otherwise penetrate through the cap 116 in corresponding locations thereof prior to contacting the wellbore plug.

In use, molten sealing material can be projected from the interior of the body 102 toward the nozzle 110, guided by the diverter 114 through the slots 112A, 112B, 112C, 112D, such that the molten sealing material exiting the apparatus 110 is projected in a pattern corresponding the position of the slots 112A, 112B, 112C, 112D, thereby contacting the wellbore plug at four locations on opposing sides of a top surface of the wellbore plug and then flowing toward and into the annular space between the wellbore plug and the rock formation of the wellbore.

While various embodiments usable within the scope of the present disclosure have been described with emphasis, it should be understood that within the scope of the appended claims, the present invention can be practiced other than as specifically described herein.

What is claimed is:

1. A system for sealing a wellbore extending through a rock formation, wherein the system comprises:
a delivery apparatus configured to be conveyed within the wellbore, wherein the delivery apparatus comprises a chamber therein; and
a sealing material disposed within the chamber, wherein the sealing material is configured to undergo an exothermic reaction when ignited, wherein the exothermic reaction produces a molten bonding material, wherein the delivery apparatus is configured to direct the molten bonding material into the wellbore such that the molten bonding material contacts the rock formation, and wherein the molten bonding material bonds with the rock formation when the molten bonding material solidifies thereby sealing the wellbore.

2. The system according to claim 1, wherein the delivery apparatus is a first delivery apparatus, and wherein the system further comprises:
a second delivery apparatus configured to be conveyed within the wellbore; and
a wellbore plug, wherein the second delivery apparatus is configured to convey the wellbore plug within the wellbore, wherein the first delivery apparatus is configured to direct the molten bonding material into the wellbore such that the molten bonding material flows into an annular space between the wellbore plug and the rock formation and contacts the wellbore plug and the rock formation, and wherein the molten bonding material bonds with the wellbore plug and the rock formation when the molten bonding material solidifies thereby sealing the wellbore.

3. The system according to claim 2, further comprising a support apparatus configured to engage a sidewall of the wellbore and support the wellbore plug within the wellbore, wherein the support apparatus forms a fluid barrier between the sidewall of the wellbore and the wellbore plug to prevent the molten bonding material from flowing out of the annular space into the wellbore below the wellbore plug.

4. The system according to claim 2, wherein the wellbore plug has a composition that is the same or similar to the composition of the rock formation.

5. The system according to claim 4, wherein the wellbore plug is:
manufactured using a molding process; or
cut out of another rock formation.

6. The system according to claim 1, wherein the sealing material comprises at least one of:
a metal and a pseudo-metal oxidizer; and
a metal and a metal oxidizer.

7. The system according to claim 6, wherein the pseudo-metal oxidizer comprises silicon dioxide, and wherein the molten bonding material comprises molten silicon.

8. The system according to claim 1, wherein the sealing material further comprises particles having a composition that is the same or similar to the composition of the rock formation, and wherein the molten bonding material bonds with the particles when the molten bonding material solidifies thereby sealing the wellbore.

9. The system according to claim 8, wherein the particles comprise at least one of clay particles, shale particles, and sandstone particles.

10. A method for sealing a wellbore extending through a rock formation, wherein the method comprises:
conveying a sealing material within the wellbore until the sealing material is positioned at a predetermined location; and
igniting the sealing material thereby causing the sealing material to undergo an exothermic reaction, wherein the exothermic reaction produces a molten bonding material that flows into contact with the rock formation, and wherein the molten bonding material bonds with the rock formation when the molten bonding material solidifies thereby sealing the wellbore.

11. The method according to claim 10, further comprising, before conveying the sealing material within the wellbore, conveying a wellbore plug within the wellbore until the wellbore plug is positioned at the predetermined location, wherein:
the conveying of the sealing material within the wellbore is performed until the sealing material is positioned at the predetermined location above the wellbore plug;
the molten bonding material flows into an annular space between the wellbore plug and the rock formation and contacts the wellbore plug and the rock formation; and
the molten bonding material bonds with the wellbore plug and the rock formation when the molten bonding material solidifies thereby sealing the wellbore.

12. The method according to claim 11, wherein the wellbore plug has a composition that is the same or similar to the composition of the rock formation.

13. The method according to claim 12, further comprising, before conveying the wellbore plug within the wellbore, performing at least one of:
manufacturing the wellbore plug using a molding process; and
cutting the wellbore plug out of another rock formation.

14. The method according to claim 10, wherein the sealing material comprises at least one of:
a metal and a pseudo-metal oxidizer; and
a metal and a metal oxidizer.

15. The method according to claim 14, wherein the pseudo-metal oxidizer comprises silicon dioxide, and wherein the molten bonding material comprises molten silicon.

16. The method according to claim 11, wherein the sealing material further comprises particles having a composition that is the same or similar to the composition of the rock formation, and wherein the molten bonding material also bonds with the particles when the molten bonding material solidifies thereby sealing the wellbore.

17. The method according to claim 16, wherein the particles comprise at least one of clay particles, shale particles, and sandstone particles.

18. A system for sealing a wellbore extending through a rock formation, wherein the system comprises:
a delivery apparatus configured to be conveyed within the wellbore, wherein the delivery apparatus comprises a chamber and a separator movably disposed within the chamber;
a gas producing material disposed within the chamber on a first side of the separator, wherein the gas producing material is configured to undergo an exothermic reaction when ignited, and wherein the exothermic reaction produces a gas; and
a sealing material disposed within the chamber on a second side of the separator, wherein the gas produced by the exothermic reaction is operable to increase pressure within the chamber to force the separator against the sealing material to thereby force the sealing material out of the chamber and into the wellbore such that the sealing material contacts the rock formation, and wherein the sealing material bonds with the rock formation when the sealing material solidifies thereby sealing the wellbore.

19. The system according to claim 18, wherein the delivery apparatus is a first delivery apparatus, and wherein the system further comprises:
a second delivery apparatus configured to be conveyed within the wellbore; and
a wellbore plug, wherein the second delivery apparatus is configured to convey the wellbore plug within the wellbore, wherein the increase in pressure within the chamber forces the separator against the sealing material to thereby force the sealing material out of the chamber and into the wellbore such that the sealing material flows into an annular space between the wellbore plug and the rock formation and contacts the wellbore plug and the rock formation, and wherein the sealing material bonds with the wellbore plug and the rock formation when the sealing material solidifies thereby sealing the wellbore.

20. The system according to claim 18, wherein the sealing material comprises sodium metasilicate (Na₂SiO₃).
